(19) United States
(12) Patent Application Publication
(10) Pub. No.: US 2011/0052453 A1
(43) Pub. Date: Mar. 3, 2011

(54) REMOVAL OF CARBON DIOXIDE FROM A FLUE GAS STREAM

(76) Inventors: Christopher McLarnon, Exeter, NH (US); Joanna Duncan, Spingvale, ME (US); Francis Alix, Rye, NH (US); Aytac Sezgi, Bedford, NH (US); Wade Amos, Gloucester, MA (US); Roberto Bosco, Rochester, NH (US); Brian Grandjean, Amesbury, MA (US); Michelle Livingston, Wolfeboro, NH (US)

(21) Appl. No.: 12/863,250

(22) PCT Filed: Oct. 31, 2008
(86) PCT No.: PCT/US08/81998

§ 371 Date: Jul. 16, 2010

Related U.S. Application Data
(60) Provisional application No. 61/084,524, filed on Jul. 29, 2008.
(60) Provisional application No. 61/021,973, filed on Jan. 18, 2008.

(30) Foreign Application Priority Data
May 1, 2008 (US) PCT/US2008/062174
May 9, 2008 (US) PCT/US2008/063265
Jul. 11, 2008 (US) PCT/US2008/069771
Aug. 22, 2008 (US) PCT/US2008/074052
Sep. 11, 2008 (US) PCT/US2008/075983

(51) Int. Cl. B01D 53/14; B03C 3/16; G01J 3/44

(52) U.S. Cl. 422/170; 96/242; 96/52; 95/183; 95/42; 356/301

(57) ABSTRACT

A method and apparatus for removing carbon dioxide and other pollutants from a gas stream having components that work synergistically. The invention includes an ammonia based scrubbing solution for SO2 scrubbing; an SO2 absorption section (250) to create contact between the flue gas and the ammonia based scrubbing solution to remove SO2 from the flue gas; a wet electrostatic precipitator to remove aerosols and fine particulate matter from the flue gas; a regenerable carbonate scrubbing solution for CO2 scrubbing, a CO2 absorption section (252) for removal of CO2 adapted to create contact between the flue gas and the scrubbing solution and which operates at a temperature between 32 and 66 degrees C. and including mass transfer apparatus and liquid distribution apparatus to provide the gas and liquid contact; an ammonia absorption section (256, 258) to capture ammonia vapor which creates contact between at least some of the liquid leaving the SO2 absorption section and the gas leaving the CO2 absorption section and return ammonia rich liquid leaving the CO2 absorption section to the SO2 absorption section for use in SO2 capture; a regeneration tower (254) to release CO2 from the scrubbing solution, the regeneration tower comprising: packing for mass transfer; apparatus for allowing the spent scrubbing solution to be introduced at elevated temperature; and apparatus for introducing heat to the regenerator tower, a controller for controlling the absorption and regeneration system parameters selected from the group consisting of gas inlet temperature, reagent feed rates, regeneration temperature and pressure, and system differential pressure; and a heat recovery device to recover energy during the heating and cooling of the absorption and regeneration column liquids.

### BACKGROUND

Most of the energy used in the world today is derived from the combustion of hydrocarbons, such as coal, oil, and natural gas. In addition to carbon and hydrogen, these fuels contain water and contaminants like sulfur, mercury, and ash. Nitrogen oxides are also formed and emitted as a result of combustion. Because of the harmful effects of these substances on human health and the environment, stringent regulations have been put in place to require power plants to use pollution control equipment. Now, carbon dioxide emissions from these plants have been targeted for similarly strict regulations because it is a greenhouse gas tied to global warming.

Others have developed pollution control equipment that treats one or perhaps two of the listed pollutants separately. They are expensive because they must treat high volumes of flue gas and low concentrations of pollutants. They have discreet inputs and outputs. Their use has a significant impact on the total cost of energy. The additional need for carbon dioxide removal makes the problem especially acute. What is needed, therefore, is a method and apparatus for removing carbon dioxide and other pollutants from a gas stream having components that work synergistically.

### SUMMARY

The invention is a method and apparatus for removing carbon dioxide and other pollutants from a gas stream having components that work synergistically. The invention comprises an ammonia based scrubbing solution for SO₂ scrubbing; an SO₂ absorption section to create contact between the flue gas and the ammonia based scrubbing solution to remove SO₂ from the flue gas; a wet electrostatic precipitator to remove aerosols and fine particulate matter from the flue gas; a regenerable carbonate scrubbing solution for CO₂ scrubbing; a CO₂ absorption section for removal of CO₂ adapted to create contact between the flue gas and the scrubbing solution and which operates at a temperature between 32 and 66 degrees C. and comprising mass transfer means and liquid distribution means to provide the gas and liquid contact; an ammonia absorption section to capture ammonia vapor which creates contact between at least some of the liquid leaving the SO₂ absorption section and the gas leaving the CO₂ absorption section and return ammonia rich liquid leaving the CO₂ absorption section to the SO₂ absorption section for use in SO₂ capture; a regeneration tower to release CO₂ from the scrubbing solution, the regeneration tower comprising: packing for mass transfer; means for allowing the spent scrubbing solution to be introduced at elevated temperature; and means for introducing heat to the regenerator tower; a controller for controlling the absorption and regeneration system parameters selected from the group consisting of gas inlet temperature, reagent feed rates, regeneration temperature and pressure, and system differential pressure; and a heat recovery device to recover energy during the heating and cooling of the absorption and regeneration column liquids. These and other features, aspects, and advantages of the present invention will become better understood with regard to the following description, claims, and accompanying drawings.

### BRIEF DESCRIPTION OF THE DRAWINGS

FIG. 1 is a process flow diagram of a basic thermal swing absorption process.

FIG. 2 is a schematic diagram of the process of the present invention synergistically coupled with another multi-pollutant control technology.

FIG. 3 is a chart showing equilibrium ammonia and CO₂ vapor pressure under absorber conditions.

FIG. 4 is a chart showing the effect of temperature on solution regeneration.

FIG. 5 is a chart showing the effect of temperature on CO2 absorption and ammonia release rates.

FIG. 6 is a chart of the steady state absorption performance in a lab scale absorption/regeneration system.

FIG. 7 is a flow chart of one embodiment of the method of the present invention used with multi-pollutant control technology.

FIG. 8 is an arrangement of an apparatus according to the method shown in FIG. 7.

FIG. 8A is a detailed schematic of a regenerator with associated equipment.

FIG. 9 is an arrangement of an apparatus according to another embodiment of the present invention.

FIG. 10 is a process flow chart of the embodiment of FIG. 9.

FIG. 11 is an arrangement of another embodiment of the present invention.

FIG. 12 is a process flow chart of another embodiment of the present invention.

FIG. 13 is an arrangement of an apparatus according to the embodiment of FIG. 12.

FIG. 14 is a process flow chart of another embodiment of the present invention.

FIG. 15 is an arrangement of an apparatus according to the embodiment of FIG. 14.

FIG. 16 is an arrangement of an apparatus according to another embodiment of the present invention.

FIG. 17 is a process flow chart of the embodiment of FIG. 16.

FIG. 18 shows the absorption spectra of carbonate and bicarbonate.

FIG. 19 is a process flow chart of another embodiment of the present invention.

FIG. 20 is a process flow chart showing a different application of the embodiment of FIG. 19.

FIG. 21 is an arrangement of an product gas clean up apparatus according to another embodiment of the present invention.

FIG. 22 is a process flow diagram of the overall process of the invention.

### DETAILED DESCRIPTION OF THE PREFERRED EMBODIMENTS

Introduction

While CO₂ emissions from power plants are currently unregulated, there is a growing consensus that standards limiting CO₂ emissions are likely to be promulgated soon. Carbon dioxide emissions from the electric power sector account for 40 percent of total U.S. energy-related CO₂ emissions. With 50 percent of U.S. electricity generated from coal and many new coal-fired electric generating plants in the planning, permitting, or construction stages, it is becoming increasingly important that CO₂ capture solutions are developed which are suitable for the existing fleet of coal-burning power plants, as well as for planned, new capacity. Today, limited CO₂ capture technologies are commercially available for use on coal-fired power plants, and none has been deployed at the scale of the typical base loaded plant. In addition, existing CO₂ capture solutions have capital and operating costs that are considered uneconomical for conventional coal-fired power plants.

The present invention includes a CO₂ capture process that can be applied to both existing and new coal-fired power plants. The process is being designed as an add-on system that could be deployed when needed and is particularly advantageous for sites where ammonia-based scrubbing is employed.

The present invention also includes a scrubbing process that uses an ammonia-based solution to capture CO₂ from flue gas. The CO₂ capture takes place after NOx, SO₂, Hg and fine particulate matter capture is accomplished in other air pollution control systems, if provided. Once CO₂ is absorbed, the resulting solution is regenerated to release it. In addition to CO₂, NH₃ is released during regeneration. It is recovered and returned to the scrubbing process, and the product CO₂ is dried and compressed into a form that is sequestration ready. Ammonia is not consumed in the scrubbing process, and no separate by-product is created.

Extensive laboratory testing on CO₂ capture using the process of the present invention has been performed. The testing has demonstrated steady-state capture/regeneration operation with 90 percent CO₂ removal under conditions comparable to a commercial-scale absorber. Based on these results, a pilot plant is being built and commercial scale units are being designed.

### Technology Overview

Post combustion carbon dioxide (CO₂) capture from coal-fired power plants takes place downstream of any employed sulfur dioxide (SO₂), nitrogen oxides (NOx), and mercury (Hg) removal process steps. When integrated with other multi-pollutant control processes, CO₂ capture takes place after the SO₂, NOx, mercury, and fine particulate matter is removed. Although the SO₂ capture efficiency of other processes can be effective (typically greater than 98%), supplemental SO₂ removal would be advantageous to a rate of 99.5% or more. This is because SO₂ must be removed in the CO₂ process as a waste, which increases the cost.

The process of the present invention uses an ammonia-based solution to absorb CO₂ from flue gas. Once the CO₂ is absorbed, the solution containing CO₂ is regenerated through heating to release the captured carbon dioxide. Ammonia and water vapor are also released during regeneration, though these are recovered and returned to the absorbing solution. The product CO₂ is then in a form that is ready for compression, pipeline transport and sequestration. The process of the present invention does not consume ammonia and no separate by-product is created by a system according to the present invention.

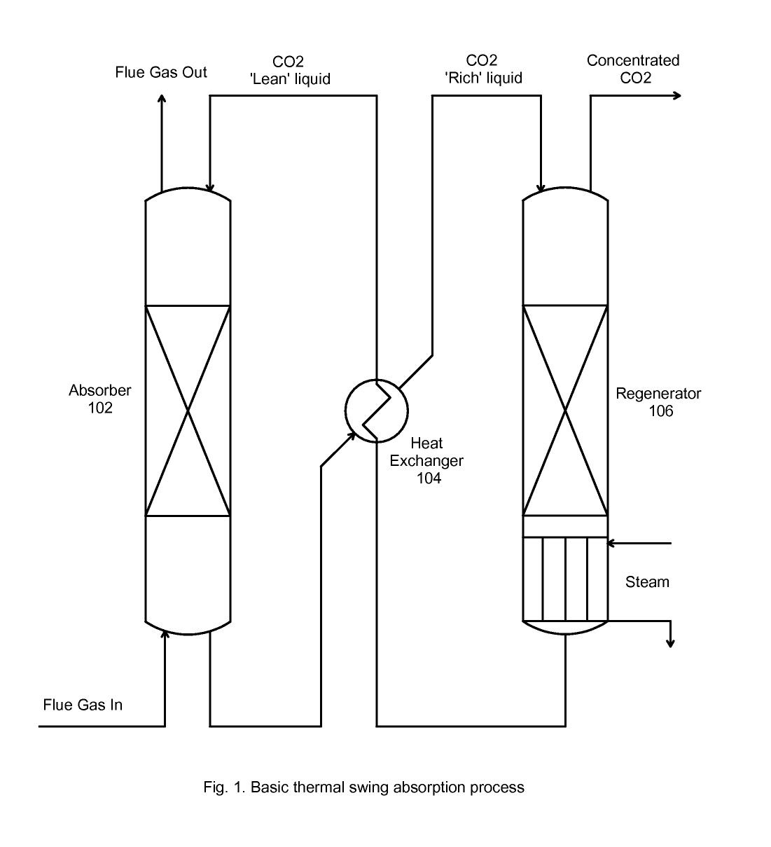

The process of the present invention is a thermal swing absorption (TSA) process for CO₂ capture. CO₂ absorption into the ammonia-based solvent takes place at low temperature, similar to temperatures achieved in wet flue gas scrubbing systems. The solvent is then heated to release the CO₂. The process is similar to other CO₂ capture technologies such as amine-based processes. Common to thermal swing absorption processes are the following key parts, which are depicted in FIG. 1.

CO₂ is absorbed in a solution through flue gas-solution contact in an absorber 102. The solution is heated by a heating means 104 for regeneration. CO₂ is released from the heated solution in a regenerator 106. The solution is cooled for reuse.

In the process of the present invention, CO₂ in the flue gas is scrubbed with an aqueous solution containing ammonium carbonate, forming ammonium bicarbonate as shown in reaction 1. The ammonium bicarbonate solution is then removed from the flue gas stream and heated, reversing the scrubbing reaction to release CO₂ while forming ammonium carbonate (reaction 2).

CO₂+(NH₄)2CO₃+H₂O→2NH₄HCO₃ (1)

2NH₄HCO₃+heat→(NH₄)2CO₃+H₂O+CO₂ (2)

CO₂ released in reaction 2 is compressed for sequestration while the ammonium carbonate solution is returned to the scrubber for reuse.

The major advantage of an ammonia-based scrubbing solution is the reduced energy of reactions (1) and (2) when compared to amine-based and other CO₂ capture processes. This substantially reduces the energy consumption associated with solution regeneration. However, ammonia's volatility requires control of ammonia vapor released to the flue gas during CO₂ scrubbing, and to the product gas during solution regeneration. The process of the present invention captures ammonia released to the flue gas during CO₂ scrubbing, reducing the concentration to less than 5 ppmv, and also recovers ammonia from the CO₂ product gas, after regeneration, for reuse.

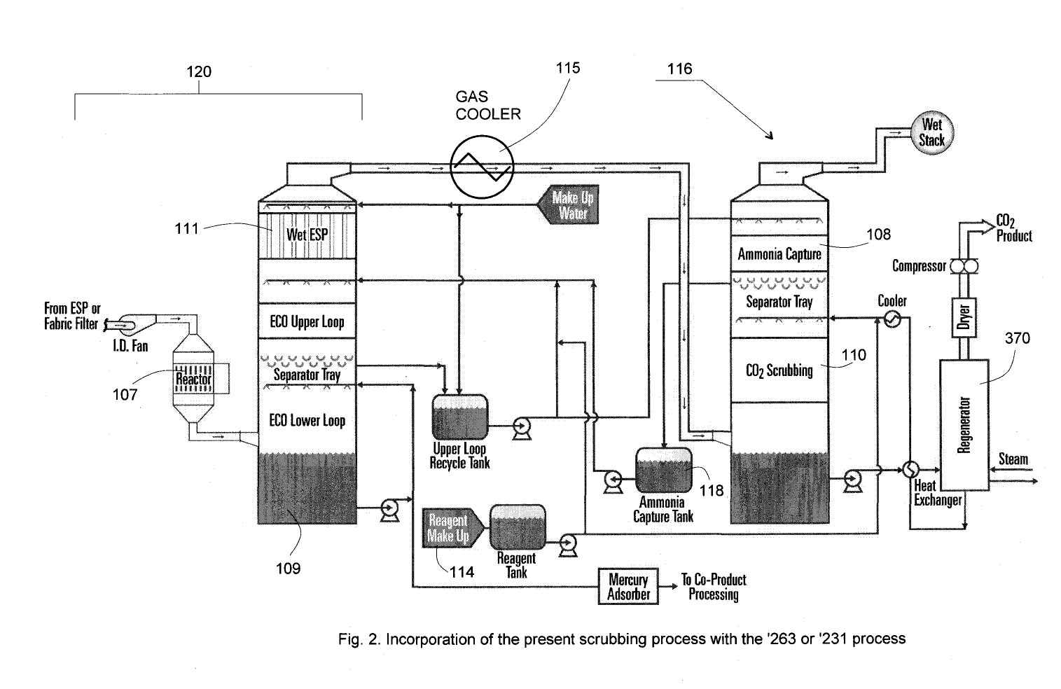

An illustration of how the process is integrated with other another multi-pollutant control systems is shown in FIG. 2 below. This example uses the system disclosed in U.S. Pat. No. 6,605,263 (the '263 process) that has a barrier discharge reactor, wet scrubber and wet electrostatic precipitator to remove high levels of NOx, SO₂, mercury, and fine particulate matter. The wet scrubber uses aqueous ammonia for SO₂ scrubbing, producing ammonium sulfate fertilizer co-product.

Managing ammonia vapor, which is released in the scrubbing and regeneration steps of the process of the present invention is an important factor in the environmental impact and process economics of using ammonia for CO₂ capture. FIG. 2 shows how ammonia vapor 108 released from the scrubber 110 is controlled using scrubbing liquor from the '263 process Upper Loop 112. In a '263 system without the CO₂ process of the present invention, ammonia is added to the upper loop scrubbing liquor. This is done after the liquor is withdrawn from the absorber, and before returning the liquor to the upper loop packed section. When CO₂ scrubbing is employed, the bulk of the ammonia addition to the '263 process upper loop is accomplished by contacting the upper loop solution with flue gas leaving the CO₂ scrubbing section. The contact takes place in the Ammonia Capture section of the present process absorber tower. The now ammonia rich liquid from the Ammonia Capture section is collected in the Ammonia Capture tank and pumped back to the '263 process Upper Loop for scrubbing of SO₂ from the flue gas. In this configuration, ammonia that would have been added directly to the '263 process is instead added to the CO₂ Scrubbing section of the present process absorber, then captured in the Ammonia Capture section and carried to the '263 absorber.

### Comparison to Amine-Based CO₂ Capture Systems

Ammonia scrubbing of CO₂ potentially offers several advantages over the commercially available amine process for CO₂ capture from coal-fired power plants. According to research conducted by the DOE-NETL and others on the use of aqua ammonia for absorption of CO₂:
1. The traditional monoethanolamine (MEA) process for CO₂ removal has disadvantages of low CO₂ loading capacity (kg CO₂ absorbed per kg absorbent); high equipment corrosion rate; amine degradation by SO₂, NO₂, HCl, HF and O₂ in the flue gas, which requires a high absorbent makeup rate); and high energy consumption during absorbent regeneration.
2. By comparison, aqua ammonia has higher loading capacity; does not pose a corrosion problem; does not degrade in a flue gas environment, minimizing absorbent makeup; requires much less energy to regenerate; and costs much less than MEA. Specifically, the aqua ammonia process compared to MEA:
   Has higher CO₂ absorption capacity;
   Requires substantially less heat to release CO₂ and regenerate absorbent; and
   Has lower reagent makeup costs.
3. Another major benefit is that removal of other pollutants (principally SO₂ and NOₓ) could be integrated with the aqua ammonia process for CO₂ removal (i.e. using the '263 multi-pollutant control technology). Due to the requirements of the MEA process, very low SO₂ flue gas is a necessary input (less than 10 ppm). Since most commercially available SO₂ scrubbing systems are not efficient enough to provide this low SO₂ flue gas to the CO₂ scrubbing system (especially on existing units with already-deployed SO₂ scrubbers), an auxiliary SO₂ scrubbing system would be needed, increasing the CO₂ capture system capital cost.

### Laboratory Testing Results

Initial laboratory testing of the CO₂ absorption process demonstrated 90 percent CO₂ removal under conditions comparable to a commercial-scale absorber: temperature 54 degrees C.; residence time 4-5 seconds; L/G 65 gpm/kacfm; flue gas containing CO₂, O₂, and N₂.

Based on these promising initial results, extensive laboratory testing has been conducted to establish the effectiveness of the process of the present invention for CO₂ capture.

The laboratory testing has consisted of: 1) verification of analytical techniques for measurement of the composition of gas and liquid streams, 2) equilibrium testing and modeling to establish limits for absorption and regeneration, 3) absorption rate testing to predict the mass transfer requirements for CO₂ absorption under commercial conditions (gas velocity, liquid to gas ratio) and in commercial mass transfer media (packing), 4) regeneration testing to establish optimal conditions for CO₂ release, 5) ammonia recovery from the regenerator off-gas and 6) combined absorption and regeneration in a cycling system that operates under steady state conditions.

Equilibrium testing under absorption conditions has been used to define the solution composition, temperature and flow rate that maintains driving force for CO₂ capture throughout the absorber. It also has established the limit on ammonia vapor release and CO₂ absorption capacity.

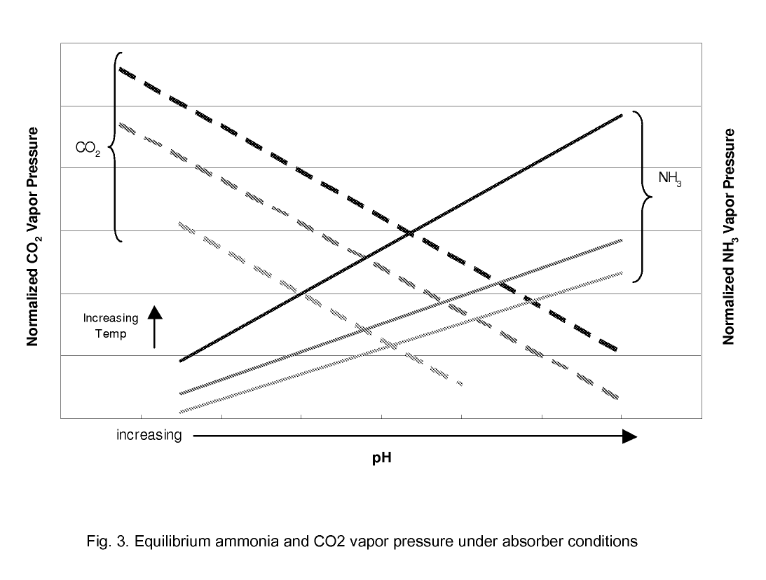

FIG. 3 shows the normalized ammonia and CO₂ vapor pressure as a function of solution pH for three temperatures. As is expected, the ammonia vapor pressure increases with increasing pH and temperature, while the CO₂ vapor pressure decreases with increasing pH, and increases with increasing temperature. Similar equilibrium testing under regeneration conditions establishes the temperature and pressure for solution regeneration and the quantity of ammonia and water vapor released relative to the CO₂ release.

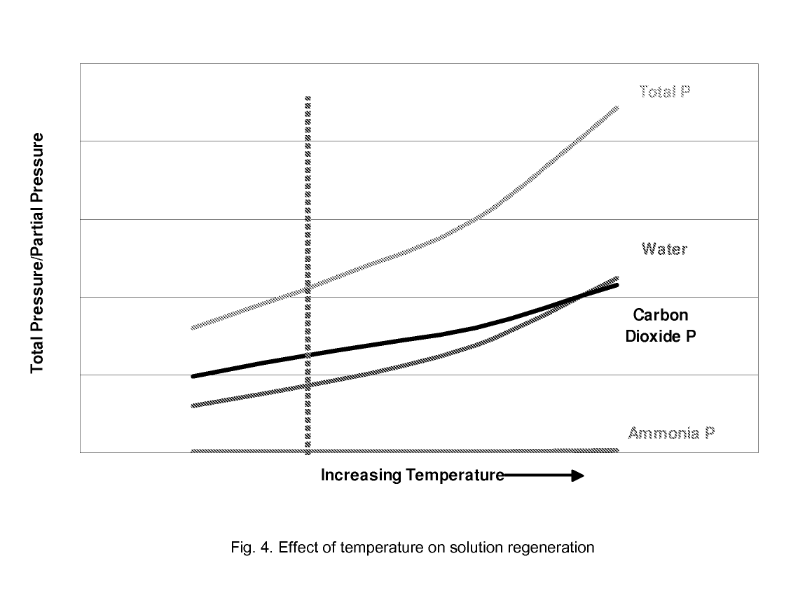

This is shown in FIG. 4, where it can be seen that increasing regeneration temperature increases the partial pressure of water vapor, CO₂ and NH₃, and therefore the total pressure. However, the figure also shows that above the design temperature the increase in water vapor partial pressure with temperature is greater than that of CO₂, increasing the relative concentration of water vapor to CO₂. The design regeneration temperature is chosen based on minimizing the energy input to the regenerator in conjunction with minimizing the compression energy required to get to final system pressure.

Absorption rate testing has been conducted in a 10 cm diameter laboratory packed tower absorber. Performance of the laboratory absorber for SO₂ and NO₂ scrubbing in the '263 process has been correlated to the performance of commercial demonstration scale 5.2 meter and 0.76 meter diameter scrubbing towers. The laboratory absorber system uses flue gas from propane combustion, into which SO₂, NOₓ, CO, O₂, N₂, CO₂, HCl and Hg are added as needed to simulate the composition of coal combustion produced flue gas. The testing conducted included the effect of packing height, gas flow rate, solution composition and temperature on CO₂ removal and ammonia vapor release.

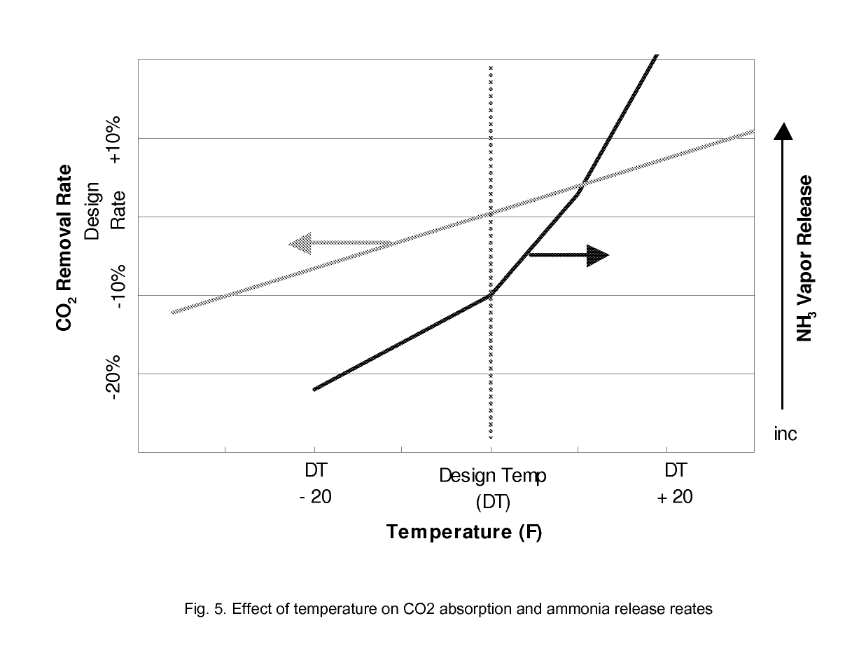

An example from the testing (FIG. 5) shows the normalized effect of temperature on CO₂ absorption and ammonia vapor release rates from the CO₂ scrubber for a given solution composition.

It can be seen that although the ammonia vapor release rate decreases with decreasing temperature, the CO₂ absorption rate also decreases. The design temperature (DT) depicted in the figure is the scrubbing temperature that maximizes the CO₂ scrubbing rate with an ammonia vapor release rate from the process of the present invention that can be controlled to less than 5 ppm.

Testing in a lab scale regenerator establishes the impact of temperature, pressure and residence time on the release of CO₂ from the absorbing solution. This testing also establishes the energy requirements for regeneration and the gas flow rates of ammonia and water. The energy input is compared to literature values to verify the regeneration reaction mechanism.

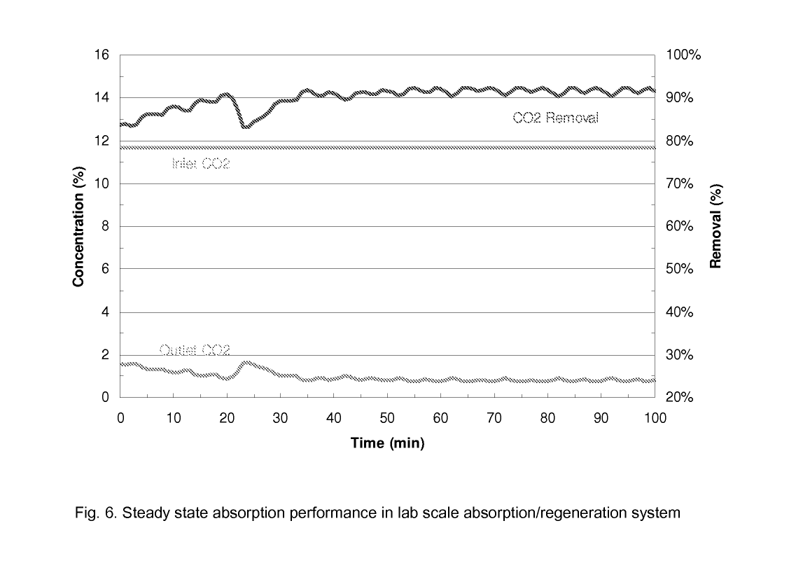

Shown in FIG. 6 are the inlet and outlet CO₂ concentrations, and the CO₂ removal for one set of operating conditions. The figure shows performance for approximately 1 hour after steady state was achieved. The solution capacity for CO₂ during the test represented by the figure was 0.03 Ibm-CO₂ per Ibm of absorbing solution, at a liquid to gas ratio of 50 gpm/kacfm.

Table 1 presents test results from the laboratory system for CO₂ absorption and solution regeneration. Concentrations of the gas entering and exiting the CO₂ absorber and exiting the regenerator are provided along with absorber and regenerator pH.

TABLE 1
CO₂ Absorption and Regeneration

| | | | | | | |
|---|---|---|---|---|---|---|
| Stream | Parameter | Units | Test 1 | Test 2 | Test 3 | Test 4 |

ABSORBER

| | | | | | | |
|---|---|---|---|---|---|---|
| Gas Inlet to CO₂ Absorber | Flue Gas Temp | (F.) | 120 | 120 | 120 | 120 |
| | Pressure | (psia) | 14.7 | 14.7 | 14.7 | 14.7 |
| | Gas Flow Rate | (L/min) | 3.0 | 3.0 | 3.0 | 3.0 |
| | CO₂ Concentration | (%) | 11.7 | 11.7 | 11.7 | 11.7 |
| Gas Exit from CO₂ Absorber | Temperature | (F.) | 115 | 112 | 110 | 109 |
| | [CO₂] | (%) | 0.7 | 1.3 | 0.8 | 0.7 |
| | [NH₃] | (%) | | 0.34 | 0.35 | 0.31 |
| | [H₂O] | (%) | | 19 | 18 | 24 |
| Lean Liquid Into Absorber | Lean Liquid Temperature | (F.) | 129 | 126 | 125 | 124 |
| | Lean Liquid Flow rate | (cc/min) | 25 | 25 | 25 | 25 |
| | pH | | 10.25 | 10.18 | 10.22 | 10.15 |
| | Specific Gravity | | 1.109 | 1.099 | 1.099 | 1.105 |
| | total [CO₃⁻²] | (wt %) | 6.8 | 6.6 | 6.5 | 6.6 |

REGENERATOR

| | | | | | | |
|---|---|---|---|---|---|---|
| Rich Liquid Into Regenerator | Rich Liquid Temperature | (F.) | 220 | 235 | 235 | 236 |
| | Rich Liquid Flow rate | (cc/min) | 25 | 25 | 25 | 25 |
| | total [CO₃⁻²] | (wt %) | 9.9 | 9.9 | 10.1 | 10.4 |
| | pH | | 9.04 | 8.97 | 8.91 | 8.98 |
| Liquid Out of Reboiler | Temperature | (F.) | 290 | 300 | 300 | 280 |
| Regen Gas Outlet | Temperature | (F.) | 223 | 220 | 226 | 225 |
| | Pressure | (psia) | 30.2 | 29.7 | 32.1 | 32.2 |
| | CO₂ | (%) | 43 | 44 | 51.5 | 46 |
| | NH₃ | (%) | 0.6 | 2.8 | 2.5 | 4 |
| | H₂O | (%) | 56 | 53.2 | 46 | 50 |

### Performance Comparison of the Present Invention

An analysis of the energy consumption of an present process, and its impact on power plant output has been made based on the laboratory results obtained to date. Shown in Table 2 is an estimate of performance comparing the process of the present invention and an MEA system retrofit on an existing coal fired power plant, obtaining 90% CO₂ removal. Data for the base plant and MEA process were obtained from “Carbon Dioxide Capture from Existing Coal-Fired Power Plants”, DOE/NETL-401/110907, Revision Date, November 2007. Shown in the table is the gross and net power output for the base plant with wet flue gas desulfurization (WFGD), an MEA process with enhanced WFGD, and the process of the present invention using the ammonia based '263 process for SO₂ removal. The analyses show that the power plant gross output is reduced from 463 MW to 449 MW with installation of the present process, and to 388 MW with an MEA system. The analysis also shows that the plant's net output is reduced by 16% when using the process of the present invention for CO₂ capture, and by 30% when an MEA system is used.

TABLE 2
CO₂ Capture Performance Comparison

| | Base Plant | MEA | Present |
|---|---|---|---|
| | w/o CO₂ | w/ enhanced | process with |
| | Capture | WFGD | ′263 process |
| Gross Output (MW) | 463 | 388 | 449 |
| Balance of Plant (MW) | 30 | 30 | 30 |
| CO₂ Capture and | | 55 | 57 |
| Compression (MW) | | | |
| Net Output (MW) | 434 | 303 | 362 |
| % Loss from Base Plant | — | 30% | 16% |

A comparison of the energy usage in MEA and process of the present invention for CO₂ capture and regeneration is shown in Table 3. The process energy consumption can be segregated into three categories: 1) sensible heat, 2) reaction energy and 3) stripping steam. The sensible heat component is the energy needed to raise the temperature of the scrubbing solution to the regenerator temperature and which cannot be recovered. Reaction energy is simply the heat of reaction for absorption of CO₂, and stripping steam is the energy associated with the steam needed or produced during the regeneration process. Table 3 shows that the energy requirement of the present process is less than that of MEA in each category. Data for the MEA system is taken from “An Economic Scoping Study for CO₂ Capture Using Aqueous Ammonia”, DOE/NETL Final Report, Revised, February 2005. The table shows that the present process total energy requirement of 493 Btu/lb-CO₂ is 27% of the MEA energy requirement of 1,812 Btu/lb-CO₂.

TABLE 3
Energy Usage in MEA and Present
Process Systems for CO₂ Capture

| | | Present |
|---|---|---|
| | MEA | Process |
| Sensible Heat | 372 | 128 |
| Reaction Energy | 825 | 277 |
| Stripping Steam | 615 | 88 |
| Total Energy | 1,812 | 493 |

### SO₂ Removal Process/'263 Process

Removing SO₂ before the CO₂ removal process of the present invention is highly desirable due to the impact on cost of CO₂ removal in the presence of SO₂. Nonetheless, a review of the chemistry involved is helpful to appreciate the synergies of a combined system using ammonia. A system that carries out the process is shown as FIG. 2 item 120. Although one tower is shown, any number of towers or reactors could be used.

### Ammonia Chemistry

If anhydrous ammonia is used, Reaction 3 shows the reaction for dissolving pure ammonia (NH₃) in water (H₂O) to form aqueous ammonia (NH₄OH).

NH₃(g)+H₂O (I)←NH₄OH (aq) (3)

For each molecule of sulfur dioxide (SO₂) absorbed, two molecules of NH₄OH are required.

### '263 Chemistry

In the '263 absorber, SO₂ in the flue gas is absorbed and dissolves in the absorber water as shown in Reaction 4. The result is sulfurous acid (H₂SO₃).

SO₂(g)+H₂O (I)←H₂SO₃(aq) (4)

Reaction 4 is reversible; the SO₂ can come back out of the solution and re-enter the flue gas unless the H₂SO₃ is reacted with another species in solution. In the case of the ECO-SO₂ process, the H₂SO₃ is reacted with NH₃. This partial neutralization reaction, shown in Reaction 5, results in the formation of bisulfite (HSO₃).

H₂SO₃(aq)+NH₃(aq)←NH₄HSO₃(aq) (5)

The bisulfate can react with another OH⁻ in Reaction 6 to form sulfite (SO₃⁻²).

NH₄HSO₃(aq)+NH₃(aq)←(NH₄)₂SO₃(aq) (6)

The relative amounts of SO₃⁻², HSO₃⁻ and H₂SO₃ depend upon the pH of the solution. If the pH goes down, the total amount of these sulfur compounds in solution will decrease and SO₂ will be released back into the flue gas. Adding ammonia increases the pH, so more SO₂ can be absorbed in the same amount of liquid. However, if the pH goes too high, Reaction 3 can go backwards and ammonia is released into the flue gas.

In order to trap the SO₂ in the liquid, the sulfite ion (SO₃⁻²) is converted through oxidation to form sulfate (SO₄⁻²). This is accomplished by blowing air through the sulfite-containing liquid. The oxygen in the air oxidizes the SO₃⁻² to SO₄⁻² as shown in Reaction 7. This reaction is not reversible and the sulfur in the sulfate form cannot re-enter the flue gas.

SO₃⁻²(aq)+½O₂(g)←SO₄⁻²(aq) (7)

The ammonium from the aqueous ammonia and the sulfate from the SO₂ eventually become the ammonium sulfate fertilizer, (NH₄)₂SO₄, which is the primary product from the '263 process. This is shown in Reaction 8.

2NH₄⁺(aq)+SO₄⁻²(aq)←(NH₄)₂SO₄(s) (8)

Reaction 9 is the net overall reaction when you combine Reactions 4 though 8: aqueous ammonia plus SO₂ and oxygen yield ammonium sulfate and some residual water.

2NH₃(aq)+H₂O (I)+SO₂(g)+½O₂(g)←(NH₄)₂SO₄(s) (9)

If one does not use the '263 process, another NH₃ capture process would have to be used.

### Embodiment 1

One embodiment of a process of the present invention is a method and apparatus for removing carbon dioxide from a gas stream and controlling ammonia vapor comprising the steps of scrubbing the carbon dioxide from the gas stream with an ammonium carbonate solution, thereby producing ammonia vapor and ammonium bicarbonate; removing a portion of the ammonia vapor from the gas stream with ammonium bicarbonate; and polishing the flue gas to achieve an ammonia concentration of less than 10 PPM.

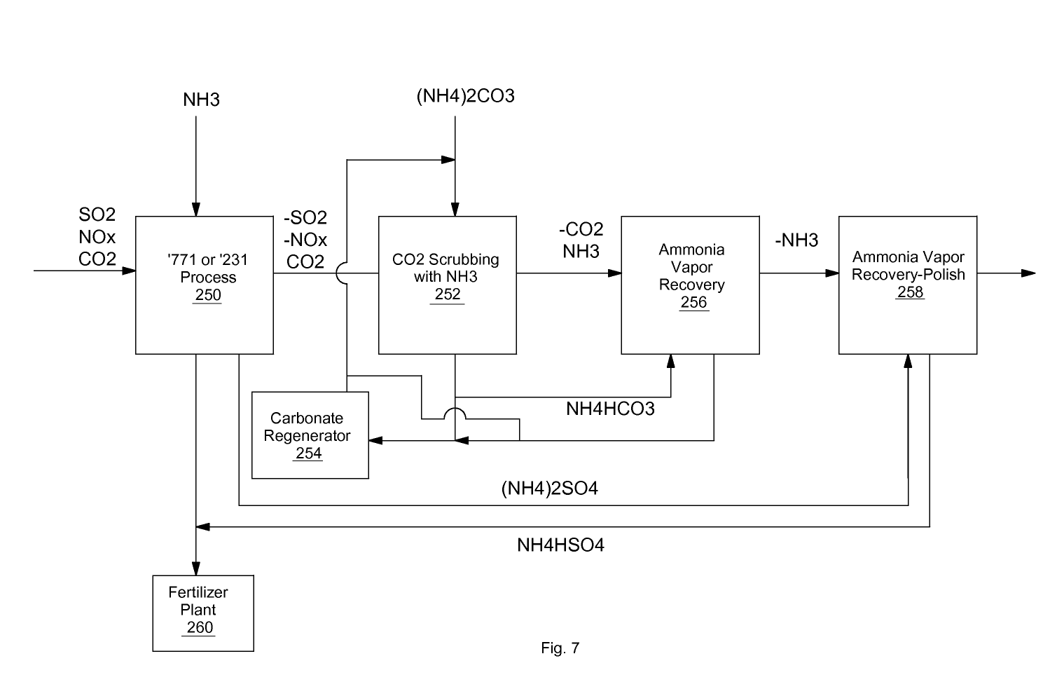

Turning to FIG. 7, flue gas typically contains SO₂, NOx, and CO₂. The SO₂ and NOx are preferably processed by the method and apparatus disclosed in U.S. Pat. No. 6,605,263, entitled SULFER DIOXIDE REMOVAL USING AMMONIA, and U.S. Pat. No. 6,936,231, entitled NOx, Hg, AND SO₂ REMOVAL USING AMMONIA. These processes will be referred to as the '263 and '231 processes and depicted in the diagram as 250. Although the '263 or '231 processes provide solutions that are some preferred methods for scrubbing NH₃ vapor released during CO₂ scrubbing, as will be shown later in this specification, other processes requiring the addition of ammonia could be used instead of the '263 and '231 processes and would be known to those skilled in the art.

The CO₂ scrubbing process and apparatus can be integral with the apparatus island of the '263 or the '231 process, or it can be in its own tower with ductwork moving flue gas from one tower to the other. Regardless, after either the '263 or '231 process 250, the CO₂ is scrubbed with an ammonium carbonate solution 252. The scrubbing produces ammonia vapor and ammonium bicarbonate, and the scrubbing solution becomes an ammonium carbonate/ammonium bicarbonate solution. A portion of the solution is drawn off to a regeneration step 254.

Another portion of the solution is drawn with the remaining flue gas, having less CO₂, to the first ammonia vapor recovery step 256. However, it is not expected that the ammonium carbonate solution will be able to recover all of the ammonia released during CO₂ scrubbing. Therefore, a second ammonia capture section 258 is necessary to decrease the NH₃ release to less than 10 ppmv.

The second ammonia step removes or captures any remaining ammonia vapor from the flue gas 258 with solution from the upper loop of either the '263 or '231 process or from the lower loop of the '263 process. The ammonia vapor concentration exiting with the flue gas is <10 ppm. In the '263 and '231 process, the upper loop requires ammonia addition to remove SO₂ and NOₓ and operates with ammonia slip of <10 ppm. The requirement for ammonia addition to the upper loop of the '263 and '231 process in addition to the ability for it to operate with low ammonia slip would enable the CO₂ scrubbing and '263 or '231 process to operate synergistically without ammonia slip. This step is called the polishing step or NH₃ capture step.

When the CO₂ scrubbing step 252 is used in conjunction with the '263 process, the lower loop solution can be used to remove the remaining NH₃ vapor from the flue gas prior to discharge to the atmosphere. The requirement for ammonia in this section is not as high as for the upper loop of the '263 process and therefore will have a smaller capacity for NH₃ vapor, but the lower pH will be a more efficient NH₃ scrubbing liquid and therefore decrease the amount of mass transfer necessary to capture the ammonia vapor. The output of the '263 and '231 process is (NH₄)₂SO₄, which can be collected for turning into fertilizer at a fertilizer plant 260, or can be used in the polishing step 258.

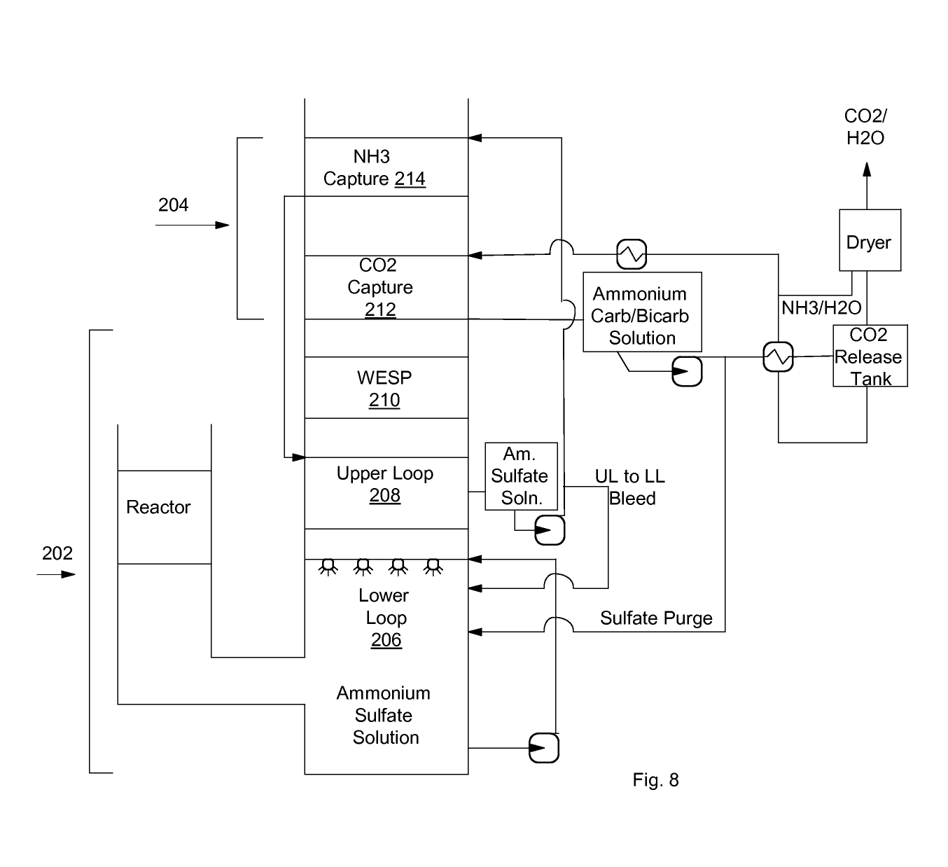

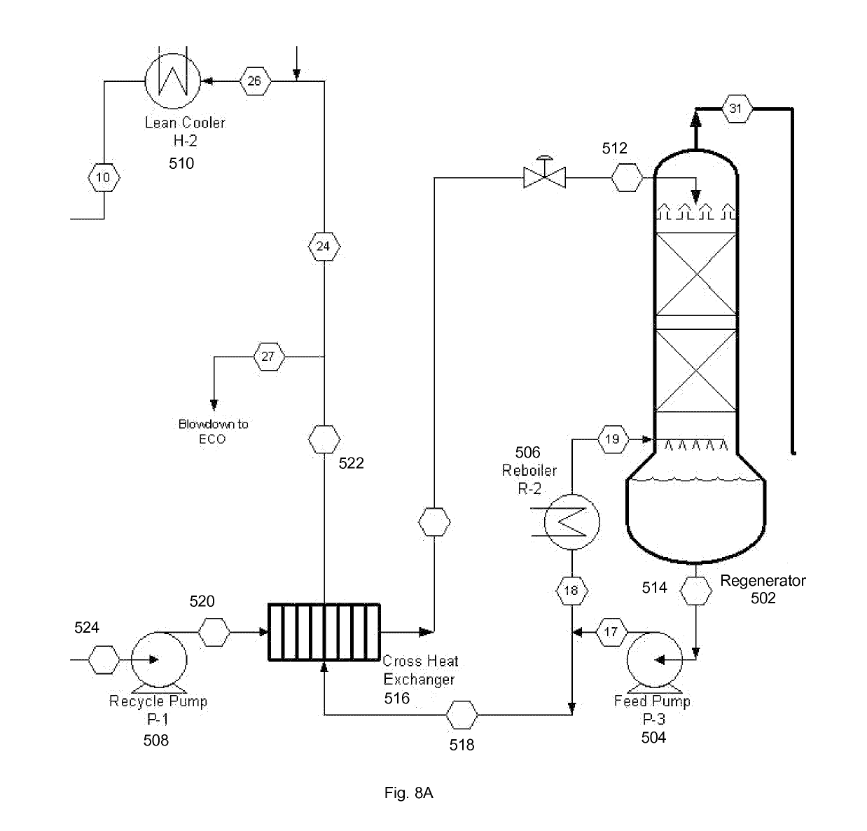

An apparatus according to the present invention is shown in the schematic of FIG. 8. A scrubbing tower 116 is provided as one embodiment, but it can be appreciated that the tower could be divided into several different apparatuses. This figure shows one approach for removing NOₓ, SO₂, and CO₂ from flue gas through modification of the '263 process, shown collectively as item 202 and comprising a reactor, lower loop 206, upper loop 208, and WESP 210. A section 204 is added to the process whether it be integral to the '771 process island 202 as shown in the figure or a stand alone tower with ductwork moving flue gas from one tower to the other and back. The initial steps of the process are the first steps of the '771 process: (i) convert NOx to NO₂ in the reactor, (ii) cool the flue gas stream to saturation in the lower loop, (iii) remove the NO₂ and SO₂ in the ‘upper loop’ of the absorber, and (iv) remove aerosols using a wet ESP (“WESP”).

The apparatus can also be modified to work in conjunction with the '231 process shown collectively as item 202 and comprising a lower loop 206 and WESP 210. A section 204 is added to the process whether it be integral to the '231 process island 202 as shown in the figure or a stand alone tower with ductwork moving flue gas from one tower to the other. The initial steps of the process are the first steps of the '231 process: (i) cool the flue gas stream to saturation in the lower loop, (ii) remove the SO₂ in the absorber, and (iii) remove aerosols with a WESP.

In order to capture CO₂, additional mass transfer sections are needed and are collectively shown as the new CO₂ and NH₃ absorption mass transfer section 204. This section will be used to remove CO₂ and NH₃ using ammonium carbonate. The CO₂ removal 212 and NH₃ capture section 214 can either be separated with a liquid redistribution tray to allow the regeneration products to be added prior to the CO₂ mass transfer section or by a separator tray to allow the liquid used to capture ammonia vapor be sent directly to regeneration. The scrubbing solution is a mixture of ammonium carbonate and bicarbonate and preferably has a carbonate concentration between 3-25 wt %. The ammonium carbonate/bicarbonate solution enters the top of the NH₃/CO₂ removal section ‘NH₃ lean’ or ‘CO₂ rich’ because it has previously been used to absorb carbon dioxide increasing the bicarbonate/carbonate ratio and decreasing the pH. Due to the increase in bicarbonate and lower pH, this solution will be able to absorb NH₃ according to the following reaction:

HCO₃⁻+NH₃→NH₄⁺+CO₃²⁻ (10)

Once the NH₃ has been absorbed, the solution will be captured in a liquid redistribution tray and NH₃/H₂O will be added from a regeneration step, which is not a part of this specification. The addition of the NH₃/H₂O will further decrease the bicarbonate/carbonate ratio (meaning the solution is ‘NH₃ rich’ or ‘CO₂ lean’) and will be able to absorb CO₂ from the flue gas stream.

### Embodiment 2

### Absorber

Another preferred embodiment is a process for removing CO₂ from a gas stream by scrubbing the CO₂ from the gas stream with a mixture of ammonium and other alkali carbonate compounds such as sodium carbonate and/or potassium carbonate.

The Absorption/Regeneration Equation that is operative in this process is:

CO₃²⁻+CO₂+H₂O←2HCO₃⁻ (11)

In the absorption process, CO₂ gas and water vapor are absorbed into a carbonate solution forming bicarbonate. It is expected that the hydration of CO₂ is the rate-limiting step of the process. Both hydroxide and ammonia increase the rate of hydration of CO₂. However, increasing the pH of the solution to a regime where hydroxide is present for CO₂ scrubbing would require a large addition of base such as NaOH or KOH. Operating an ammonium carbonate solution under conditions where the CO₂ hydration is fast and the capacity of CO₂ is large enough to be economical brings the process into a regime where the ammonia vapor pressure is large and difficult to manage. Therefore, a mixture of ammonia with another alkali such as potassium or sodium is used to maximize the absorption capacity of the solution for CO₂, maintain the high rate of CO₂ hydration during the scrubbing process, and minimize the ammonia volatility and release from the absorption process.

The process of the present invention, like the '263 process, uses ammonia in the absorber section. Instead of absorbing SO₂, the present invention process uses the ammonia to help absorb carbon dioxide (CO₂) from power plant flue gas. For the present invention process to work properly, most of the SO₂ must be removed from the flue gas before it enters the present invention process.

The source of the ammonia for the present invention process is aqua ammonia (NH₄OH). The carbon dioxide in the flue gas dissolves into the absorber water to form carbonic acid (H₂CO₃) as shown in Reaction 12.

CO₂(g)+H₂O (I)←H₂CO₃(aq) (12)

Some of the CO₂ reacts with the NH₃ from to form ammonium bicarbonate (HCO₃⁻) as shown in Reaction 13.

H₂CO₃(aq)+NH₃←NH₄HCO₃(aq) (13)

The bicarbonate can further react with more NH₃ to from ammonium carbonate ((NH₄)₂CO₃) as shown in Reaction 14.

NH₄HCO₃(aq)+NH₃(aq)←(NH₄)₂CO₃(aq) (14)

For the CO₂ absorption in the present invention process, the carbonate from Reaction 14 reacts with the carbon dioxide in Reaction 12 to form two bicarbonate ions as shown in Reaction 15.

H₂O (I)+(NH₄)₂CO₃(aq)+CO₂(aq)←2NH₄HCO₃(aq) (15)

During the regeneration reaction, the HCO₃⁻ is converted back to the carbonate CO₃⁻² form as the captured CO₂ is released (see regenerator Reaction 18).

The net absorption reaction from combining Reactions 12 and 15 is shown below.

CO₂(g)+(NH₄)₂CO₃(aq)+H₂O (I)→2NH₄HCO₃(aq) (16)

One undesirable side reaction is the release of some ammonia from the present invention absorber solution. Reaction 17 is the reverse of the Reaction 3. Aqueous ammonia in the absorber liquid enters the flue gas as gaseous ammonia (NH₃). This lost ammonia is referred to as ammonia “slip” and most of this ammonia is recaptured at the top of the present invention absorber and converted to ammonium sulfate. (See capture Reactions 23 through 26.)

NH₄OH (aq)←NH₃(g)+H₂O (I) (17)

### Maintaining Proper Water Balance in the Absorber

Depending on the inlet and outlet temperatures to and from the absorber of the present invention, there may be a net change in the amount of water leaving with the treated flue gas. If the inlet flue gas to the absorber is saturated and at a higher temperature than the absorber, water vapor in the flue gas may condense in the absorber. Likewise, if the inlet flue gas is not saturated or is at a significantly lower temperature than the absorber temperature, net evaporation occurs and water is lost from the absorber carbonate solution to the outlet flue gas.

There is a significant benefit to operating the absorber of the present invention under conditions where there is a net loss or no loss of water from the absorber liquid to the flue gas. Under these conditions, water is continually added to the absorber and the purge rate from the absorber is controlled to limit the buildup of inert substances in the carbonate solution. If a significant amount of water condenses out of the flue gas into the carbonate solution in the absorber (more than the purge required for inert removal), the purge rate may be controlled by the increase in water in the system and would require a higher purge rate to control water buildup. This higher purge rate results in higher losses of carbonate counter-ion and other additives that may be in the absorber solution.

Turning to FIG. 2, one means to prevent excess water accumulation in the carbonate solution is to cool the flue gas from the '231 process 120 with a gas cooler 115 before it enters the absorber 116. The '231 process and equipment 120 also includes an oxidation means that could be a dielectric barrier discharge reactor 107, an ammonia-based scrubbing solution 109, a wet electrostatic precipitator 111, and upper loop 112. Additional apparatus includes a reagent makeup 114 and ammonia capture tank 118. FIG. 7 shows the method, in which the cooling step would be between the '231 process 250 and CO2 scrubbing process 252. As the flue gas is cooled, some water vapor in the flue gas may condense out of the flue gas. This condensed water can be used as the makeup water to the process or for other applications at the power plant. The primary purpose, and benefit, of cooling the inlet flue gas is to control the water balance in the absorber itself to reduce the purge rate from the process of the present invention. It also reduces the required size of the gas cooler, which saves capital expense, and is an example of the synergy between the '231 process and the process of the present invention. Instead of using a gas cooler 115, others have cooled liquid water, which misses the benefits of the water balance according to the present invention.

Once the absorption solution is saturated with CO₂ it must be regenerated. The solution is regenerated by heating the solution to release CO₂ as shown as the reverse of Reaction 11.

### Regenerator

The liquid leaving the bottom of the absorber contains the absorbed CO₂ in the form of bicarbonate ion (HCO₃⁻) plus the ammonium from the aqueous ammonia. During regeneration, Reaction 15 is reversed as shown below.

2HCO₃⁻(aq)←CO₂(g)+H₂O (I)+CO₃⁻²(aq) (18)

The carbonate ion (CO₃⁻²) consumed during absorption Reaction 15 is recovered in Reaction 18.

The regeneration energy is very important to the economics of the process. Evaluation of the reaction energies suggests the energy consumption for Reaction 11 is the same whether Na⁺, K⁺ or NH₄⁺ is used. However, to operate the Na⁺ or K⁺ system in a regime for fast CO₂ absorption would also require the regeneration of the base. Since both NaOH and KOH are strong bases, the energy consumption for recovery is likely to limit the applicability for the Na⁺ and K⁺ analogs. The ΔHᵣₓₙ=−44.5 and −57.5 kJ/mol for the dissolution of NaOH and KOH respectively. However, with NH₃ present in solution, the high rate of CO₂ hydration is still available and since NH₃ is a weak base the dissolution energy is 5 kJ/mol allowing regeneration of ammonia in the mixed alkali solution to be economically feasible in the process.

The following is a detailed description of the regenerator of the present invention. CO₂ is removed from the flue gas of coal-fired power plants through absorption into a carbonate solution. Due to the mass flow of CO₂ in the flue gas, economics require that the process provide a way to release the CO₂ and reuse the carbonate solution. For the present invention, a thermal swing absorption process is used.

FIG. 8A shows a drawing of the regenerator system. The regenerator consists of the following major pieces of equipment: (i) regenerator tower 502, (ii) feed pump 504, (iii) re-boiler 506, (iv) re-cycle pump 508, cross heat exchanger 516 and (v) lean cooler 510.

Regenerator Tower—The regenerator tower 502 is the mass transfer device that allows the CO₂ vapor to be released. Rich CO₂ liquid is fed into the top of the tower through stream 512. This rich liquid comes from the absorption tower after CO₂ has been absorbed from the flue gas stream. As the liquid travels down the regenerator tower it interacts with the vapor rising up the column, and condenses water vapor and releases CO₂ converting bicarbonate to carbonate in the solution. It uses at least one packing section 505. At the same time the concentration of CO₂ in the gas stream increases and the concentration of water vapor decreases. The pH and temperature of the feed solution increases as it goes down the column due to the release of CO₂ and shift from bicarbonate to carbonate. Once in the tower reservoir, the solution is regenerated and is pumped either back to the absorber or to the reboiler 506.

The conditions the regenerator tower operates at will dictate the composition of the CO₂ leaving the regenerator. The pressure of the tower is dictated by the temperature of the liquid leaving the regenerator (stream 514) while the composition of the gas out of the regenerator is dictated by the equilibrium conditions of the feed liquid entering the regenerator (stream 512). The temperature profile down the tower increases from top to bottom, with the highest temperature at the bottom. The pH of the solution increases from top to bottom, with the highest pH solution at the bottom. The composition of the liquid, the total carbonate concentration, decreases from top to bottom with the lowest total carbonate concentration at the bottom.

Re-boiler—Integral to the regenerator is a heat exchanger that we have been calling a “reboiler” 506. The term is common is distillation and stripping operations but one actually does not boil the liquid within the device. But like a reboiler it is the means to put energy into the system, causing regeneration of the scrubbing solution. The total energy supplied by the reboiler 506 is to meet the needs for regeneration, which consist of 1) the heat of reaction to liberate CO₂ from the bicarbonate solution, 2) the sensible heat change required to get the reaction to proceed at a commercially practical rate and 3) the energy for of vaporizing water and ammonia, which is to be minimized but also occurs. The reboiler 506 is fed with a portion of the liquid leaving the regenerator tower. In the reboiler the liquid is heated to an elevated temperature, but kept under pressure so that no boiling occurs. The heated solution is then sprayed into the bottom of the regenerator, at which point a portion of the liquid evaporates (or flashes). The temperature of the reboiler outlet liquid established the regenerator pressure, which is used to maximize the CO₂ content of the regenerator outlet gas. By heating only a portion of the regenerator outlet liquid and returning it to the reboiler one is able to keep the bulk temperature of the regenerator low while maintaining a higher pressure than the bulk temperature would allow. This increases the CO₂ content of the regenerator outlet gas, reducing the total energy input required of the process.

Cross Heat Exchanger—The amount of steam the process consumes can be dramatically reduced with heat integration. The method of heat integration in this invention is the use of a cross heat exchanger 516 in which hot lean solution (stream 518) preheats the rich cool solution (stream 520) before entering the regenerator tower 502 and at the same time cools the lean solution (stream 522) before it is returned to the absorber to be reused. The cross heat exchanger 516 is a plate heat exchanger and is based on design approach temperature of 4-6 degrees C. This is required due to the large amount of energy, which needs to be transferred between the rich and lean solutions, and reduces the sensible heat input requirement. The approach temperature of the cross heat exchanger is a critical part of energy management in the process of the present invention.

Feed Pump/Recycle Pump—Recycle pump 508 is used to transfer desired amount of rich cold solution from absorber (stream 524) to cross heat exchanger 516. Hot lean solution from regenerator (stream 514) is fed to both the re-boiler 506 and to the cross heat exchanger 516 with feed pump 504.

Lean Cooler—Since the cross heat exchanger only provides a 4-6 degrees C. approach temperature, some cooling of the solution is required prior to reintroducing the liquid to the absorber to achieve the required inlet absorption temperature. The lean cooler 510 uses cooling water to achieve the additional 4-6 degrees C. of cooling required. The cooling load is an additional cost of the system of the present invention, so again good performance and low approach temperatures are required from the cross heat exchanger 516 to provide reasonable costs for energy in the process.

Summary—The regenerator 502 is a critical piece of equipment in the process of the present invention. The design must provide for heat recovery and promote CO₂ to be released with minimum water and ammonia evaporation to be economical.

### Alternative Regenerator Configurations to Reduce Heating and Cooling Requirements.

The basic process of this invention uses steam to supply the heat to the carbonate solution using a reboiler 506. The vapors (stream 503) leaving the regenerator 502 contain a mixture of carbon dioxide, ammonia and water vapor. These vapors are cooled to remove some of the water and ammonia before compression. Alternative designs to reduce both heating and cooling requirements include a multi-effect design and a vapor recompression design.

In a multi-effect design, steam (or another heat source) is used to supply heat to one regenerator (Regenerator #1). The heat from condensing the vapors leaving Regenerator #1 could be used as the heat source to another regenerator (Regenerator #2). The vapors from Regenerator #2 could likewise be used to supply heat to yet another regenerator, or cooling water could be used to cool the vapors and recover a portion of the ammonia and water, just as in the basic process of the present invention. Typically the regenerators in a multi-effect design would operate at different pressures to optimize heat transfer. The regenerators may also be different sizes to match the condensation heat from the vapors with the reboiler heat requirements of the subsequent regenerator. The benefit of this design is to decrease the overall heating and/or cooling water requirements for the overall process.

In a vapor recompression design, the vapors leaving the regenerator are compressed and then the heat from condensing the vapors is used as the heat supply to the same regenerator. The compression step is done to increase the temperature at which the vapors condense to allow heat transfer. Some steam may be used to supplement the heat requirements, but the heat in the vapor is used directly to supply heat to the regenerator. Like with the multi-effect design, the overall external heating and cooling requirements are reduced for the process.

In the process of this invention there are significant opportunities for heat recovery and integration. The heat removed from the regenerator vapors and lean liquor may be at high enough temperatures to heat other process streams within the present process or at the attached power plant. Likewise, heat recovery from the compression steps of the present process may also be used within this process or for heating process streams at the attached power plant.

### Ammonia Capture

As mentioned previously, some ammonia is released from the absorption section of the present invention process. Since this is a regulated compound, it must be recaptured from the flue gas to reduce ammonia emissions and limit the ammonia make-up requirement. Although the present process regenerator process does not consume ammonia, some is lost to the capture section and that ammonia is converted to ammonium sulfate. A small amount of ammonia (˜5 ppm) is released from the present invention ammonia capture section into the exiting flue gas.

The first step of the ammonia capture section is to dissolve the ammonia gas (NH₃) back into the water in the capture solution via Reaction 19. Forming ammonium sulfate requires two molecules of ammonia per ammonium sulfate molecule. Note that Reaction 17 is reversible, so the pH must be low to retain the NH₃ in the liquid and not release it back into the flue gas.

2NH₃(g)+2H₂O (I)←2NH₄OH (aq) (19)

The overall capture reaction is shown in Reaction 20.

2NH₃(g)+SO₂(aq)+½O₂+2H₂O (I)→(NH₄)₂SO₄(s) (20)

The net effect is that the ammonia added to the present invention process is lost from the CO₂ absorption section but reabsorbed in the capture section. When it is reabsorbed, it provides the NH₃ to capture more SO₂. In other words, the same amount of ammonia is added to the overall system: two molecules of NH₃ for every molecule of SO₂. If the process is running with only '263 process, the ammonia is added to the present invention absorber. If the present invention process is running, some of the ammonia added to the present invention absorber escapes to the capture section and then it is sent back to the '263 process. The ammonia that escapes from the present process is re-used in the '263 scrubber and does not result in a net increase in ammonia consumption. This is an example of a synergy in the system.

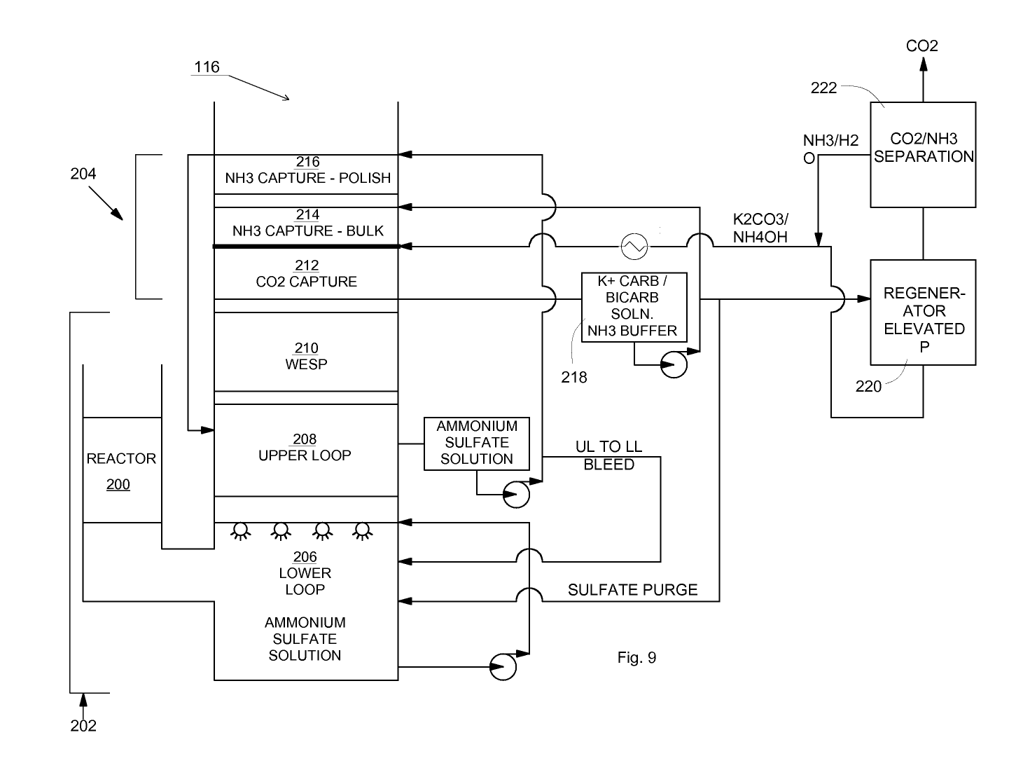

Turning to FIG. 9, the scrubbing tower 116 is broken into two sections, 202 and 204, as in the previous embodiment. For more efficient removal of CO₂, the SO₂ and NOₓ are removed from the flue gas stream 202. The preferred method of SO₂ and NOₓ removal is through an ammonia scrubbing solution similar to that described in U.S. Pat. Nos. 6,605,263 and 6,936,231 where flue gas is cooled to saturation in a lower loop 206 prior to entering a mass transfer section. In the mass transfer section upper loop 208 the SO₂ and NOₓ are removed using a pH controlled ammonium sulfate solution. Finally, aerosols or paticulates are removed using a device such as a wet electrostatic precipitator 210. Once SO₂ and NOₓ are removed from the flue gas stream, the carbon dioxide is captured in the CO₂ capture section 212.

The solution used in the CO₂ capture section is a mixture of potassium and ammonium carbonate or sodium and ammonium carbonate 218. The solution goes through the CO₂ mass transfer section 212, removing CO₂ from the flue gas stream and producing a carbonate/bicarbonate solution. The mixed alkali bicarbonate solution is then regenerated by heating at an elevated temperature 220 releasing CO₂, NH₃, and H₂O. The CO₂ is separated from the NH₃ and H₂O 222 and is a substantially pure CO₂ stream that could be further processed to produce a sequestration-ready CO₂ stream. The NH₃ and H₂O are returned to the regenerated potassium carbonate solution and fed back into the scrubber.

Experiments have shown there are acceptable ranges of concentrations and acidity of the carbonate/bicarbonate solution to carry out the process of the present invention. It has been found that an acceptable range of carbonate/bicarbonate concentration is 5 to 20 wt %, ammonium is 0.1 to 3 wt % and alkali is 4 to 25 wt %. The solution would have a pH between 8.5 and 12.

Experiments have also shown optimum ranges of concentrations and acidity of the carbonate/bicarbonate solution. The optimum carbonate/bicarbonate concentration of 7 to 8 wt %, ammonium of 0.20 to 0.25 wt %, and potassium of 7 to 8 wt %. The optimum pH range is between 10 and 10.5.

Some advantages of using a mixed alkali system include:
1. Lower ammonia vapor pressures for solutions with the same capacity compared to ammonium carbonate solutions
2. Higher rate of CO₂ hydration and therefore requirements for smaller mass transfer devices compared to sodium or potassium carbonate scrubbing solutions.
3. Higher carbonate concentrations for a given pH can be run compared to ammonium carbonate solutions improving the capacity of the solution.

### Embodiment 3

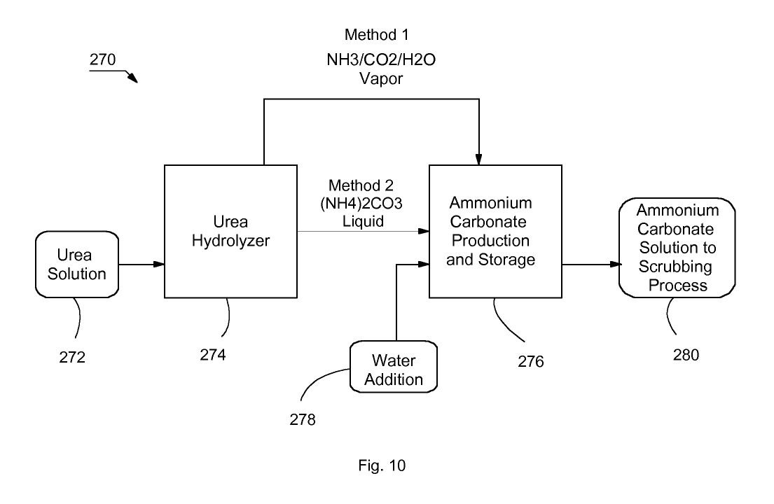

This is an optional embodiment of the present invention in which the ammonium carbonate used in the absorber is made onsite from urea. It is a method and apparatus that teaches how a urea solution is hydrolyzed and captured to form an ammonium carbonate solution, as well as how the system is controlled to maintain the performance of an ammonia scrubber. FIG. 10 shows a process 270 according to the present invention. A urea solution 272 is provided in the range of 10-60% by weight of urea.

In method 1, the urea is heated in a closed vessel, hydrolyzer 274. As the urea solution is heated the urea decomposes and releases CO₂, NH₃, and water vapor. The vapor stream is released from the hydrolyzer vessel and contacted 276 with water in an ammonium carbonate solution tank. The CO₂, NH₃, and water vapor condense and react to generate additional ammonium carbonate solution. As the ammonium carbonate solution is removed from the ammonium carbonate tank to be used in a process as ammonia, the pressure control valve on the hydrolyzer opens to release more vapor to replace the ammonium carbonate that was used. Opening the valve decreases the pressure in the hydrolyzer. As the pressure decreases, heat input increases to decompose more urea and generate additional CO₂, NH₃, and water vapor. Water is added 278 to the ammonium carbonate tank to maintain the desired concentration by monitoring the specific gravity or conductivity of the. It is desirable to maintain the concentration of ammonium carbonate between 5 and 30 wt % so the minimum amount of water is added 278 to the ammonia scrubbing process.

In method 2, the urea is also hydrolyzed in a urea hydrolyser 274. In this case, as the temperature of the urea solution is increased, the pressure is maintained high enough to inhibit vaporization of the CO₂, NH₃, and water vapor. Instead the reaction proceeds in the liquid phase as shown in equation 21.

NH₂CONH₂+H₂O→(NH₄)₂CO₃ (21)

Completing the reaction in the liquid phase requires substantially less energy since no vaporization is taking place. In addition, this reaction is highly exothermic and therefore the heat generated from the conversion of urea to ammonium carbonate can sustain the decomposition of urea with minimal energy input. The rate of urea conversion in the liquid phase depends on the temperature of operation. Increasing temperature increases the rate of conversion in the range of 38-260 degrees C. (100-500 degrees F.). In this method, the initial urea concentration can be chosen to provide the desired ammonium concentration after conversion or to minimize energy, more concentrated urea solutions can be used and water can be added to the product ammonium carbonate to attain the desired ammonium carbonate concentration.

Once the ammonium carbonate solution is generated, it can be used as an ammonia substitute in processes requiring ammonia addition. For example, ammonium carbonate solution is added 280 to a process that removes SO₂ using ammonia. Ammonium carbonate is added to the solution instead of aqueous ammonia to maintain pH as required based on the desired pollutant removal percentage.

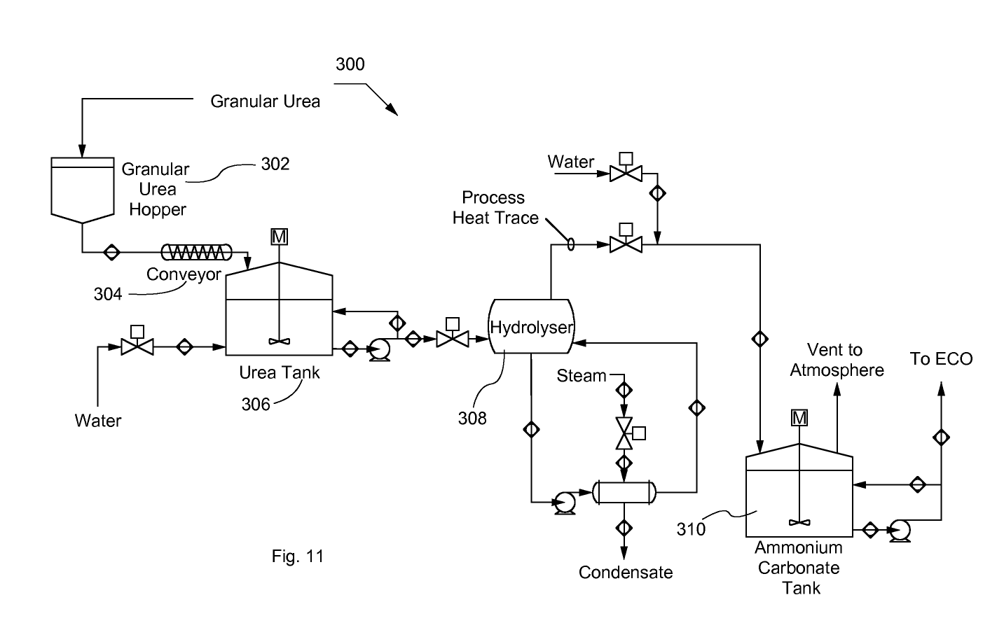

Turning to FIG. 11 the sample apparatus 300 of the present invention starts with urea in a hopper 302. The urea is fed by a conveyor 304 to a urea tank 306 where it is maintained at a concentration between 10% and 60% by weight.

The urea solution is hydrolyzed in a hydrolyser 308 to create an NH₃, CO₂, and water vapor stream (method 1) or an ammonium carbonate solution (method 2). For method 1, the vapor stream is held at elevated temperatures, meaning a temperature above that used in decomposition, until it is brought into contact with water in an ammonium carbonate solution tank 310 to prevent additional reactions from occurring which create solids in the vapor transport line. Water is added to the ammonium carbonate tank to keep the concentration of ammonium carbonate between 5% and 30% by weight. Ammonium carbonate solution is then added to an ammonia scrubbing process to maintain pH as required based on a desired percentage of pollution removal.

### Embodiment 4

The next embodiments focus on the regeneration steps. The invention comprises the steps of providing a solution containing NH₄HCO₃/(NH₄)₂CO₃ made by carbon dioxide scrubbing; adding Na₂CO₃ to precipitate NaHCO₃ and release NH₃ vapor; capturing the NH3 vapor to make reusable for carbon dioxide scrubbing; and decomposing the NaHCO₃ with heat greater than 60 degrees C. to release carbon dioxide.

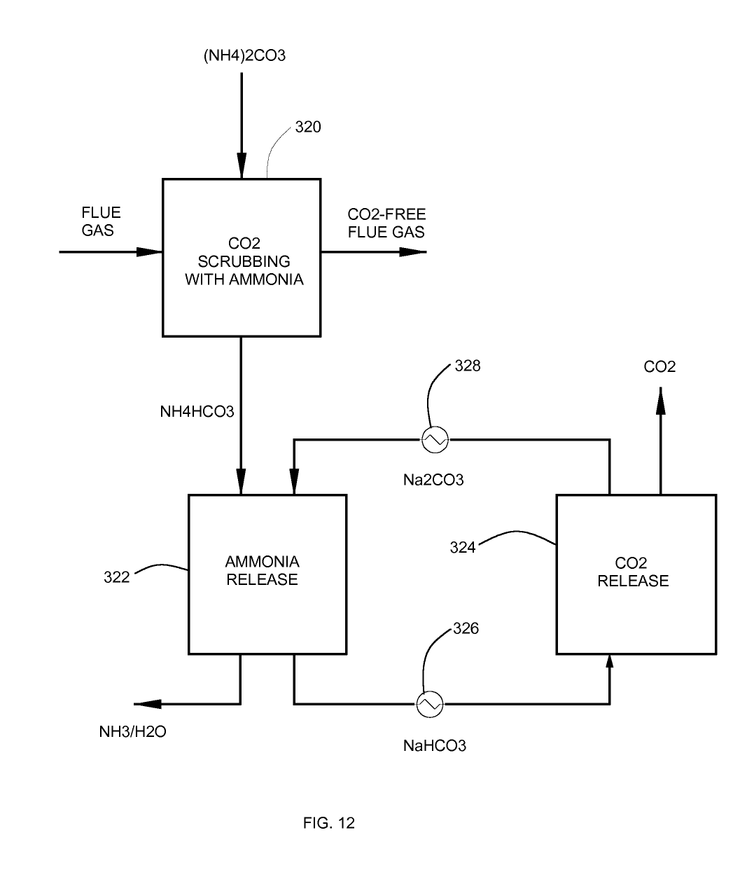

FIG. 12 is a flow chart of the process of the present invention. The ammonium carbonate/bicarbonate solution comes from a carbon dioxide scrubbing process and apparatus with ammonium carbonate 320 that results in a solution of NH₄HCO₃/(NH₄)₂CO₃. The solution is transferred to the regeneration system to recover NH₃ and CO₂.

In this approach, Na₂CO₃ is added to the NH₄HCO₃/(NH₄)₂CO₃ solution used in the scrubbing process 320 to precipitate NaHCO₃ and release NH₃ vapor in the ammonia release step 322. This can be done at elevated temperature to make the NH₃ release more efficient. Once released, the NH₃/H₂O vapor mixture would need to be cooled or condensed or captured by other means such as absorption or adsorption prior to sending back to the carbon dioxide scrubbing process 320 mentioned above.

The NaHCO₃ slurry can then be heated 326 for decomposition. This step may require that the solid NaHCO₃ be separated from the NH₄HCO₃/Na₂CO₃ solution using a filter and rinse to avoid carrying NH₃/NH₄⁺ to the decomposition reactor/CO₂ release tank where it could be released with the CO₂ 324. This may also make the decomposition more efficient because one can bring over only the NaHCO₃ and create a very concentrated solution limiting the amount of water that needs to be heated. The decomposition of NaHCO₃ occurs at temperatures >60° C. and is described by the following reaction:

2NaHCO₃(aq)→Na₂CO₃(aq)+H₂O (I)+CO₂(g) (22)

The decomposition process 324 recovers the Na₂CO₃ required to release the NH₃ and has been done commercially as part of the Solvay process to create Na₂CO₃. Again some cooling 328 will be required prior to returning the Na₂CO₃ to the NH₃ recovery due to the need for the NH₃ recovery and the CO₂ recovery to operate at different temperatures. The temperature values chosen are based on physical property information. This is an improvement over what others have used in the past to recover NaHCO₃ for their dry scrubbing steps. The difference is that there is not necessarily a requirement for a purge step that would remove sodium from the process. Since it is not volatile, it will not be carried out in either of the recovery steps, minimizing the need for sodium makeup.

Depending on the amount of ammonium sulfate, nitrate, and chloride compounds captured in a carbon dioxide scrubbing mass transfer section, it may be necessary to purge sulfates, nitrates and chlorides from the ammonium carbonate/bicarbonate solution to the UL or LL of the sulfur dioxide scrubbing mass transfer section. This would cause the CO₂ to be released back into the scrubber and would also keep the amount of sulfates, nitrates, and chlorides in the ammonium carbonate scrubbing and regenerating loops to a minimum. The size of this stream will depend on the capture efficiency of the upper loop and by the amount of aerosols that are captured in the carbon dioxide scrubbing mass transfer section.

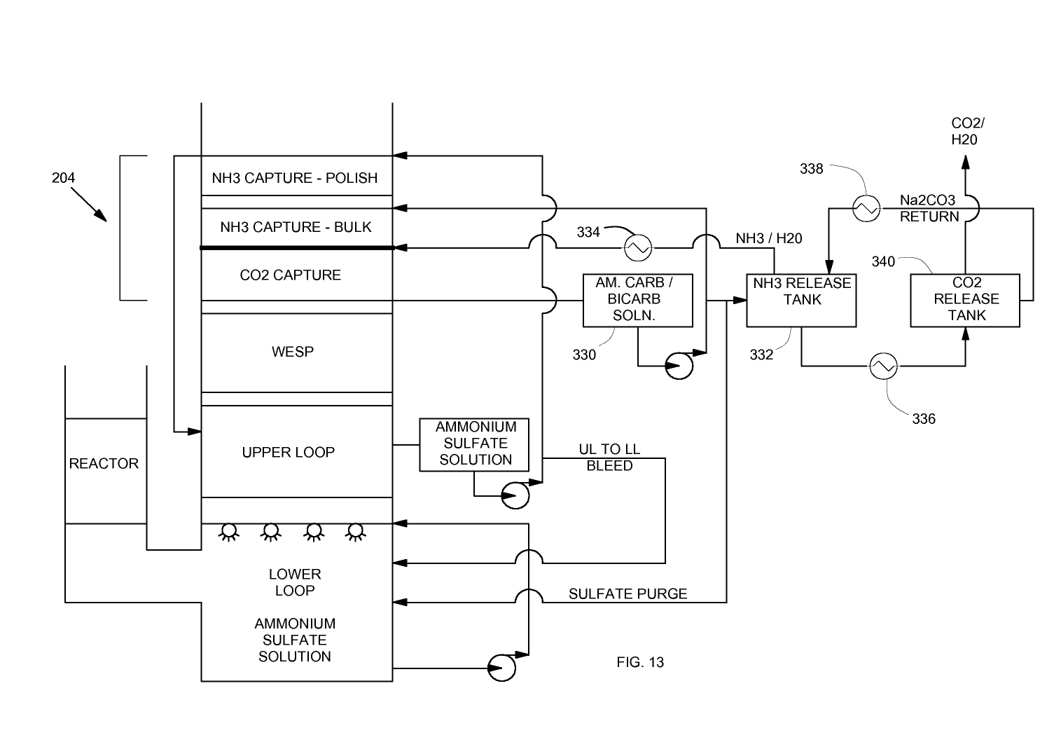

FIG. 13 is a schematic diagram of an apparatus according to the present invention. Ammonium carbonate/bicarbonate solution comes from a carbon dioxide scrubbing process and apparatus 204 with ammonium carbonate that results in a solution of NH₄HCO₃/(NH₄)₂CO₃ in a tank 330. The solution is transferred to the regeneration system to recover NH₃ and CO₂.

In this approach, Na₂CO₃ is added to the NH₄HCO₃/(NH₄)₂CO₃ solution 330 used in the scrubbing process to precipitate NaHCO₃ and release NH₃ vapor in the NH₃ release tank 332. This can be done at elevated temperature to make the NH₃ release more efficient. Once released, the NH₃/H₂O vapor mixture would need to be cooled, condensed, or captured by other means such as absorption or adsorption 334 prior to sending back to the carbon dioxide scrubbing process.

The NaHCO₃ slurry can then be heated and sent to a heater 336 for decomposition. This step may require that the solid NaHCO₃ be separated from the NH₄HCO₃/Na₂CO₃ solution using a filter and rinse to avoid carrying NH₃/NH₄⁺ to the decomposition reactor/CO₂ release tank 340 where it could be released with the CO₂. This may also make the decomposition more efficient because one can bring over only the NaHCO₃ and create a very concentrated solution limiting the amount of water that needs to be heated.

The decomposition process recovers the Na₂CO₃ required to release the NH₃ and has been done commercially as part of the Solvay process to create Na₂CO₃. Again some cooling with a cooler 338 will be required prior to returning the Na₂CO₃ to the NH₃ recovery due to the need for the NH₃ recovery and the CO₂ recovery to operate at different temperatures.

Depending on the amount of ammonium sulfate, nitrate, and chloride compounds captured in the carbon dioxide scrubbing mass transfer section 204, it may be necessary to have a purge stream from the ammonium carbonate/bicarbonate tank 330 to the UL or LL of the carbon dioxide scrubbing mass transfer section 204. This would cause the CO₂ to be released back into the scrubber and would also keep the amount of sulfates, nitrates, and chlorides in the ammonium carbonate scrubbing and regenerating loops to a minimum. The size of this stream will depend on the capture efficiency of the upper loop and by the amount of aerosols that are captured in the carbon dioxide scrubbing mass transfer section 204.

### Embodiment 5

This embodiment is a method and apparatus for controlling ammonia and water vapor from a stream created from the decomposition of ammonium carbonate, returns the ammonia and water reagents to other processes for reuse and creates a carbon dioxide stream that is sequestration ready comprising the steps of washing the gas stream mixture containing carbon dioxide, ammonia, and water with a CO₂ rich carbonate solution; condensing water vapor with a cooling step, drying the remaining gas stream to a dewpoint of less than −40 degrees C. (−40° F.), and compressing the purified carbon dioxide stream to sequestration pressures.

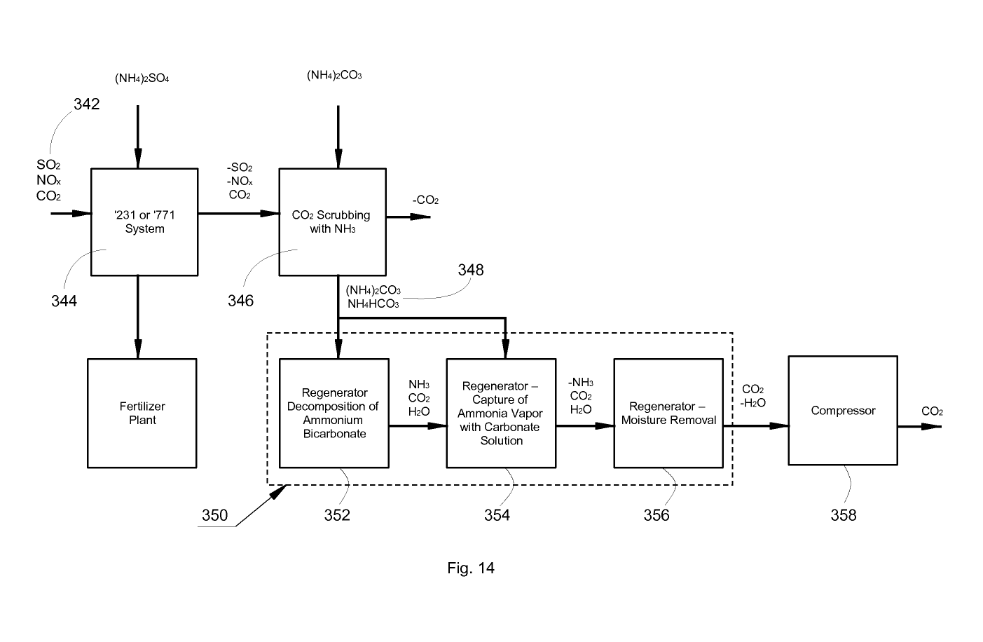

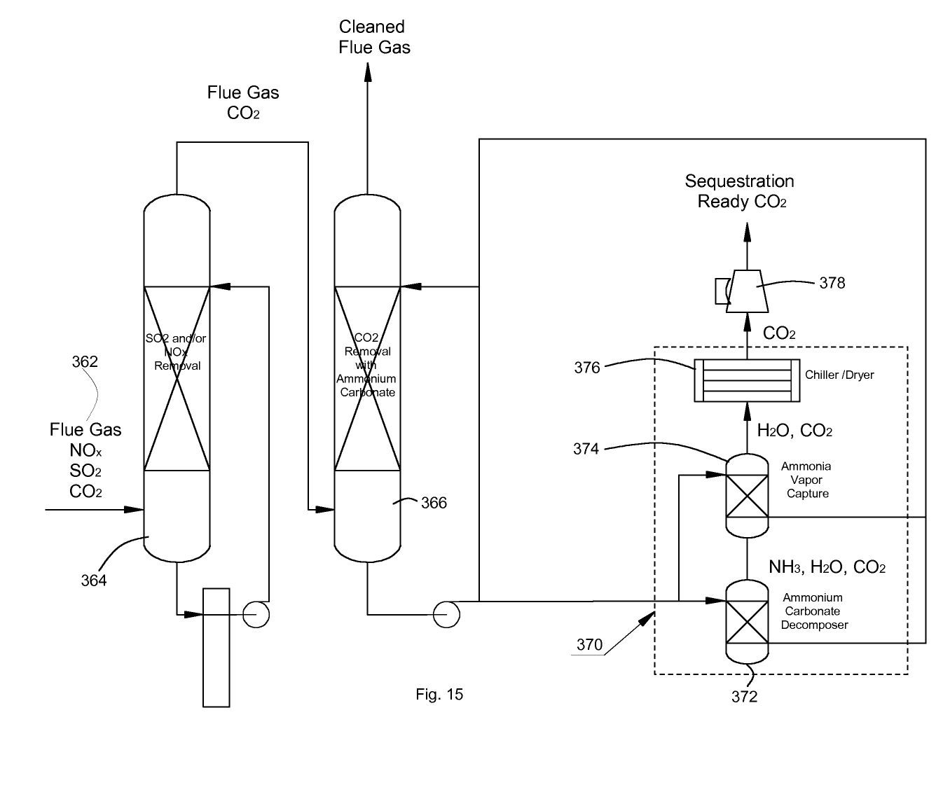

Turning to FIG. 14 and FIG. 15 at the same time, flue gas typically contains SO₂, NOx, and CO₂ 342, 362. The SO₂ and NOₓ are preferably processed by the method and apparatus disclosed in U.S. Pat. No. 6,991,771, and U.S. Pat. No. 6,936,231. It is referred to in this specification as the '231 System 344, 364. The CO₂ scrubbing process and apparatus can be integral with the apparatus island of the '771 or the '231 process, or it can be in its own tower with ductwork moving flue gas from one tower to the other and back. Regardless, after either the '771 or '231 process 344, the CO₂ is scrubbed with an ammonium carbonate solution 346 in a scrubbing apparatus 366. The scrubbing produces ammonium bicarbonate, and the scrubbing solution becomes an ammonium carbonate/ammonium bicarbonate solution 348. A portion of the solution is drawn off and sent to a regeneration step 110 to recover ammonia and produce carbon dioxide for sequestration.

In the ammonium carbonate regenerator 370 that performs the regeneration step 350, the ammonium carbonate solution is heated in an ammonium carbonate decomposer 372 to decompose the ammonium carbonate solution to carbon dioxide, ammonia and water vapor 352 via the following reactions:

2NH₄HCO₃→(NH₄)₂CO₃+H₂O+CO₂↑ (23)

(NH₄)₂CO_{3(aq)}→CO_{2(g)}+NH_{3(g)}+H₂O_{(g)} (24)

For the CO₂ to be acceptable for sequestration, the ammonia and water must be removed from the gas stream. One method to remove the ammonia is to use a CO₂ rich solution to wash the gas stream. The CO₂ rich solution is preferably composed of a concentrated carbonate solution used for CO₂ scrubbing prior to the regeneration step and is at a temperature of 38-66 degrees C. (100-150° F.) and atmospheric pressure. The gas stream that is to be washed to remove NH₃ is preferably at a temperature of >66 degrees C. (150° F.) and a pressure of 0.69-34 bars (10-500 psi).

A separate mass transfer section(s) is needed to wash the ammonia laden gas stream, the new NH₃ absorption mass transfer section. This section will be used to remove NH₃ using ammonium carbonate. The NH₃ capture 354, 374 is separated with a liquid redistribution tray but not a separator tray. The scrubbing solution is a mixture of ammonium carbonate and bicarbonate. The concentration of the ammonium carbonate solution is dictated by the CO₂ absorption process but should be as concentrated as possible to improve the efficiency of the regenerator. The ammonium carbonate/bicarbonate solution enters the top of the NH₃ removal section ‘NH₃ lean’ or ‘CO₂ rich’ because it has previously been used to absorb carbon dioxide increasing the bicarbonate/carbonate ratio and decreasing the pH. Due to the increase in bicarbonate and lower pH, this solution will be able to absorb NH₃ according to the following reaction:

HCO₃⁻+NH₃→NH₄⁺+CO₃²⁻ (25)

Once the NH₃ has been absorbed, the carbonate solution continues to the regeneration step. The carbon dioxide stream is now ammonia free and is sent to a heat exchanger 376 to further cool the gas stream to less than 54 degrees C. (130° F.). The process of cooling the gas stream causes the water vapor to condense and will also capture any remaining ammonia vapor in the flue gas stream 356. Further or alternative drying of the flue gas can be done using commercially available processes including but not limited to the use of molecular sieves or membranes. The remaining carbon dioxide can be handled by being compressed 358 with a compressor 378.

### Embodiment 6

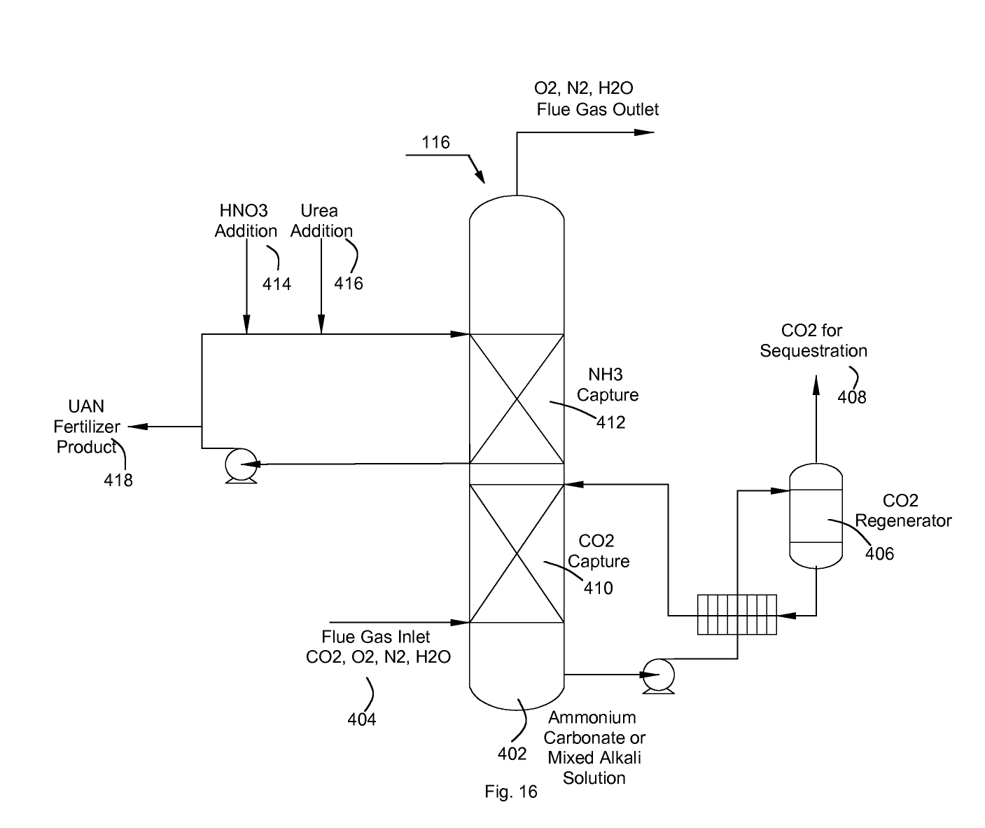

This embodiment is used with the '231 or '771 process and involves scrubbing of ammonia with urea ammonium nitrate solution. As shown in FIG. 16, the ammonium carbonate or mixed alkali solution 402 is circulated to absorb CO₂ from a flue gas stream containing CO₂, H₂O, O₂, and N₂ 404. The solution is sent through a regenerator 406 to produce a concentrated CO₂ stream 408 ready for sequestration. Once regenerated the solution is recycled back to the CO₂ capture section 410 to absorb more CO₂. In the process of absorbing CO₂ ammonia is released. The amount of ammonia released is determined by the conditions of absorption and the composition of the absorbing solution but will be between 100-8000 ppm. After the CO₂ is captured, the flue gas moves to an ammonia capture mass transfer section 412 where a concentrated urea ammonium nitrate solution is circulating. The solution is pH adjusted to between 4 and 6 with nitric acid 414 to make the solution ammonia lean and forms ammonium nitrate as shown in equation (26).

HNO₃+NH₃→NH₄NO₃ (26)

Urea 416 is added to the solution either prior to the NH₃ capture 412 or after the formation of the ammonium nitrate to maintain a concentrated urea ammonium nitrate solution 418 ready for commercial distribution.

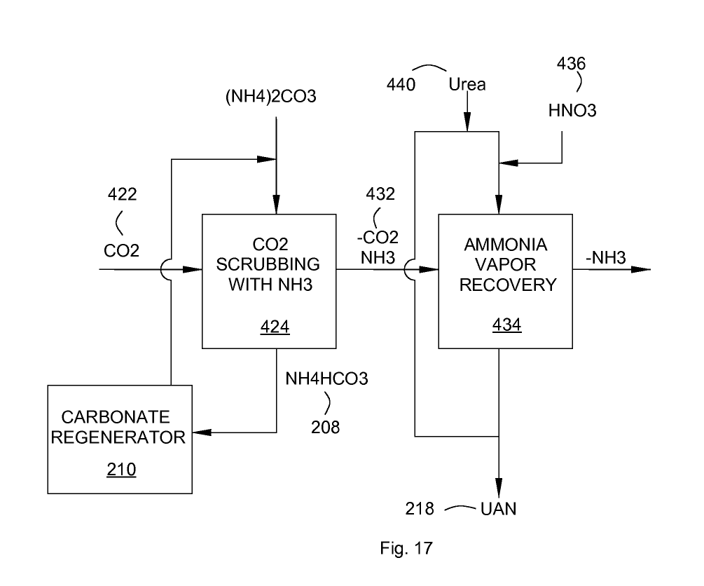

As shown in FIG. 17, a flue gas stream containing CO₂ 422 is brought into an absorption section 424 that uses an ammonium carbonate solution to absorb CO₂. The ammonium carbonate is converted into ammonium bicarbonate 428 through reaction of CO₂ with CO₃²⁻ as shown in (27):

CO₂+CO₃²⁻+H₂O→2HCO₃⁻ (27)

The ammonium bicarbonate solution is introduced into the regenerator 430, to reverse reaction (27) creating a concentrated CO₂ stream, which can be processed for sequestration or beneficial use. The regenerated solution is re-introduced into the absorber tower 424 to remove more CO₂.

Due to the volatility of the ammonium carbonate solution, the flue gas exits the absorber 204 with >70% CO₂ having been removed and with the addition of ammonia vapor. The CO₂ lean flue gas 432 now enters an ammonia vapor recovery 434 section to remove the ammonia vapor prior to leaving the stack. In the ammonia vapor recovery section, nitric acid 436 is added to a urea ammonium nitrate (UAN) solution to decrease the pH to <6. The UAN absorbs the ammonia vapor from the flue gas in a gas liquid contactor. When the UAN exits the contactor, part of the solution is removed as product 438 ready to be used as a fertilizer product while the rest is recycled back to the ammonia vapor recovery section 434. Additional urea 440 and HNO₃ acid 436 are added to maintain the required ratios of UAN and to maintain the ability to absorb NH₃ vapor.

The advantages of using UAN to do ammonia absorption as part of a CO₂ scrubbing process are:
1. The ability to produce a nitrogen fertilizer, which is the predominant plant nutrient required by crops.
2. The ability to produce a nitrogen fertilizer with minimal capital cost. Since the ammonia capture is required in the CO₂ scrubbing process, only incremental increases are required for the nitrogen fertilizer production including pumps and storage allowing one to take advantage of the infrastructure already in place.

### Embodiment 7

This is another optional embodiment related to using Raman spectroscopy to control carbonate/bicarbonate concentrations. The invention is a method of controlling carbonate/bicarbonate concentrations in a chemical process having the steps of a) flowing a carbonate/bicarbonate solution through a measurement cell, (b) exposing the solution to laser light of suitable wavelength and power; c) measuring the intensity of the scattered light using Raman spectroscopy; and d) calculating the concentration of carbonate and bicarbonate from the intensity of the scattered light and (e) sending the measurement results to a programmable logic controller (PLC) to be used to control the ratio and concentration of carbonate and bicarbonate in the solution through adjusting process parameters.

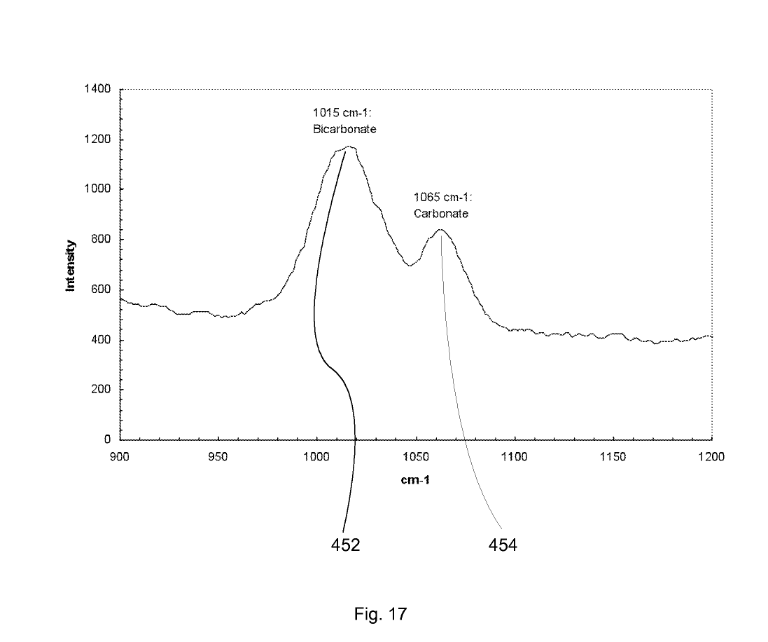

Raman spectroscopy depends upon the inelastic scattering of monochromatic light. The incident light usually comes from a laser in the visible or ultraviolet range. When carbonate and/and bicarbonate are irradiated with the laser light, they shift the frequency of the light. This shift can be measured for both carbonate and bicarbonate and occurs at different frequencies. Turning to FIG. 18, bicarbonate has a peak 452 at approximately 1015 cm⁻¹ and carbonate has a peak 454 at approximately 1065 cm⁻¹.

By measuring the intensity of the scattered light either by peak height or peak area, the concentrations of each component can be determined. These two concentrations can then be used to calculate total carbonate.

The invention involves using Raman spectroscopy to identify and quantify carbonate and bicarbonate real time in a process that relies on the ratio of carbonate, and bicarbonate present as well as the total carbonate concentration. To our knowledge, there are presently no alternatives to performing this online.

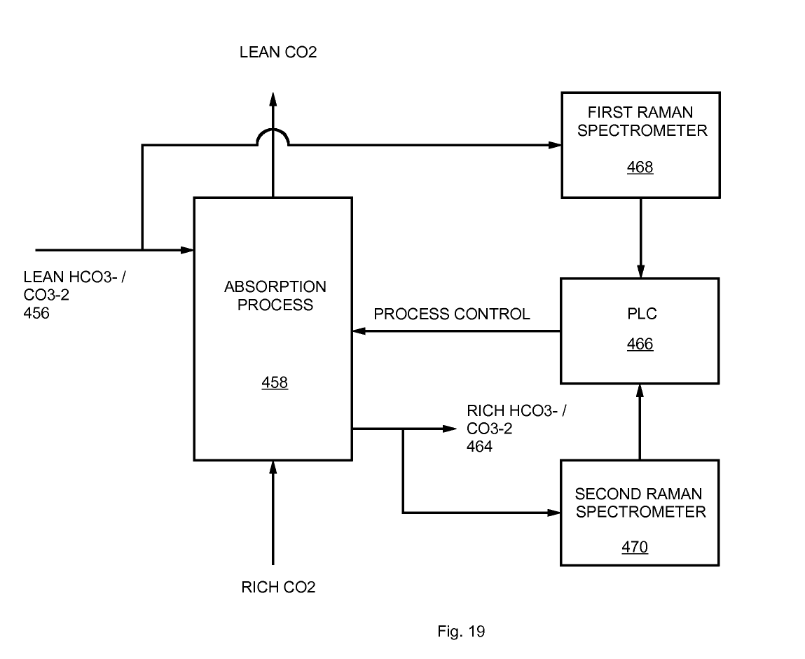

One embodiment is a carbon dioxide scrubbing process where carbonate and bicarbonate are the main components as shown in FIG. 19.

A “carbonate lean” solution 456 is introduced to a CO₂ absorption process 458. A carbonate lean solution contains a ratio of HCO₃⁻/CO₃²⁻ less than 1. Its composition is measured by a first Raman spectrometer 468. As CO₂ is absorbed into the carbonate solution, the following general reaction will take place:

CO₃⁻²+H₂O+CO₂→2HCO₃⁻ (28)

As this occurs, the total carbonate and carbonate/bicarbonate ratio will change. A “carbonate rich” solution with HCO₃-/CO₃⁻² ratio greater than 1 will exit the absorption process 464. Its composition is measured by a second Raman spectrometer 470. The carbonate/bicarbonate solution can be but is not limited to Na₂CO₃/NaHCO₃, (NH₄)₂CO₃/NH₄HCO₃, and K₂CO₃/KHCO₃. The important factor for controlling the ratio of carbonate and bicarbonate in the solution is that the carbonate be soluble in the solution being measured.

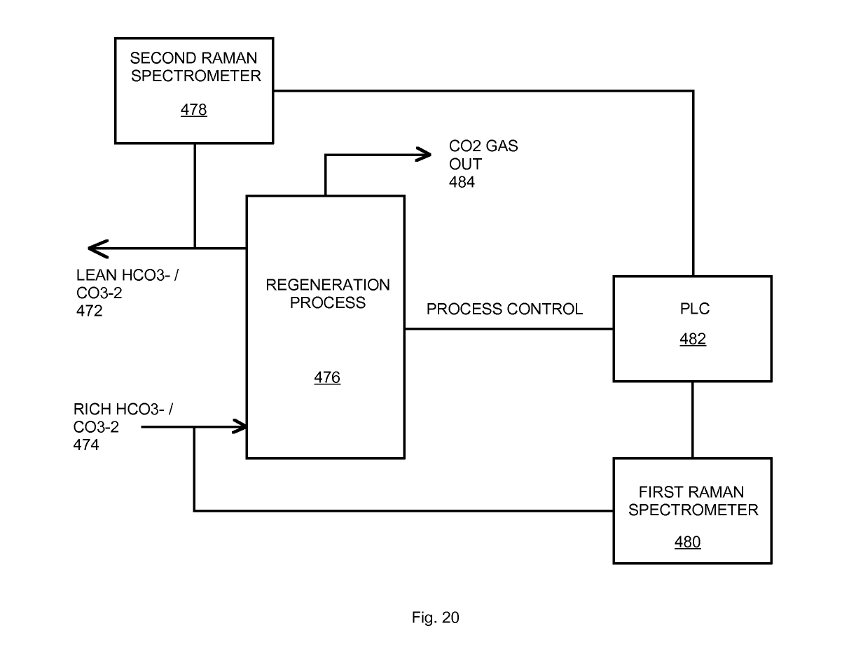

The Raman spectrometers steps 468 and 470 operate more precisely in the following manner as shown in FIG. 20. The method comprises the steps of flowing a carbonate/bicarbonate solution through a measurement cell, exposing a carbonate/bicarbonate solution with laser light of suitable wavelength and power; measuring the intensity of the scattered light using Raman spectroscopy; calculating the concentration of carbonate and bicarbonate from the intensity of the scattered light, and sending the measurement results to a PLC to be used to control the ratio of carbonate to bicarbonate, and total carbonate in the solution

This method would be used to control the total carbonate concentration and to control the ratio carbonate concentration to bicarbonate concentration. The concentration values would be sent to a (“PLC”) 466 as feedback to the process control loops to the process 458. These factors are important because if the carbonate to bicarbonate ratio is not controlled it would lead to poor absorption efficiency. If the total carbonate concentration is not controlled, it would lead to “salting out” or precipitation of the carbonate solution fouling mass and heat transfer surfaces. The method provides feedback to the PLC for adjusting parameters such as, but not limited to liquid flow rates, reagent addition rates, and temperatures.

Turning to FIG. 20, another embodiment and process in which this invention can be used is the production of carbon dioxide from alkali carbonate/bicarbonate solutions. This can also be characterized as a carbonate/bicarbonate regeneration process 476. To produce CO₂ from alkali carbonate/bicarbonate solutions such as, but not limited to Na₂CO₃/NaHCO₃, (NH₄)₂CO₃/NH₄HCO₃, and K₂CO₃/KHCO₃, the reaction of equation (25) above is reversed. Bicarbonate is converted to carbonate, water and CO₂.

In such a process, feedback will be necessary to determine if the solution has been regenerated 476 to the degree required to by the process. A method of doing this is to measure the carbonate and bicarbonate concentrations along different points of the process.

A rich HCO₃⁻/CO₃⁻² solution, that is bicarbonate to carbonate ratio greater than 1, 474 is introduced to a regeneration process 476. Its composition is measured by a first Raman spectrometer 480. CO₂ gas 484 is produced as a result of the regeneration process 476. A lean HCO₃₋/CO₃⁻² solution, that is bicarbonate to carbonate ratio less than 1, 472 exits the regeneration process. Its composition is measured by a second Raman spectrometer 478.

Information from the first and second Raman spectrometers 480, 478 would be fed to a PLC 482, which would then control an energy input to the regeneration process 476. The Raman spectrometers would provide real time data input to a PLC or other automated controller that could then be used for either regeneration 476 or absorber 458 control.

One embodiment of a measurement system could include, but not be limited to, the following:
Sample probe;
Data transfer cables from probe to spectrometer;
Spectrometer;
Computer; and
Output to PLC (analog or digital).

### Embodiment 8

This is an embodiment describing clean up of the product gas. In the present process, CO₂ is removed from the flue gas of coal-fired power plants through absorption into a carbonate solution. Due to the mass flow of CO₂ in the flue gas, economics require that the process provide a way to release the CO₂ and reuse the carbonate solution. For the present invention a thermal swing absorption process is used. During the regeneration process, carbon dioxide along with ammonia and water vapor are released. The ammonia and water vapor must be removed prior to sequestration of the CO₂.

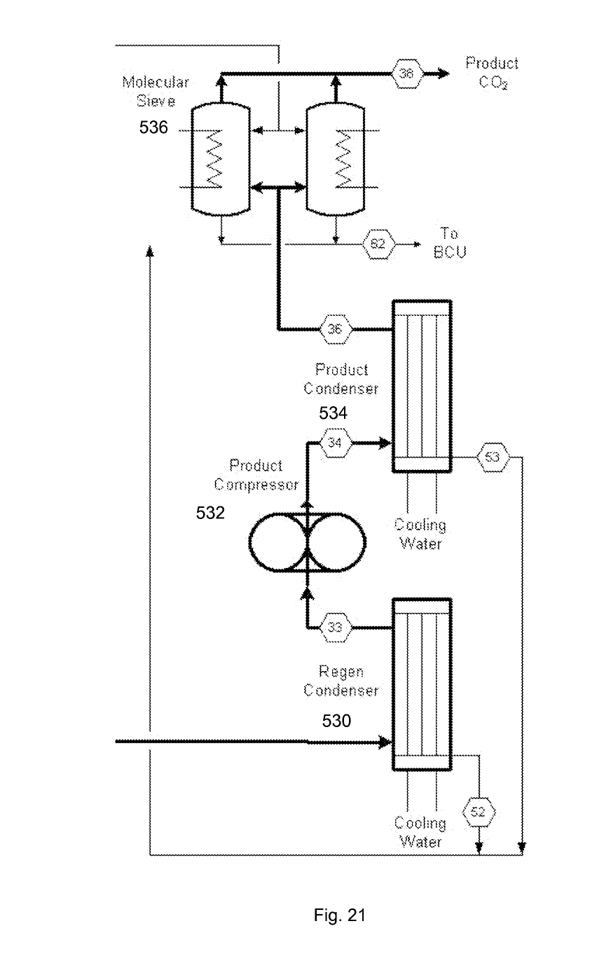

FIG. 21 shows a process flow diagram (“PFD”) of the CO₂ product gas cleanup process. The CO₂ product gas cleanup process consists of (i) regen condenser 530, (ii) compressor 532, (iii) product condenser 534, and (iv) molecular sieve (or other standard drying system) 536.

The goal of the CO₂ product gas cleanup process is to remove H₂O and NH₃ from the CO₂ gas stream to make it sequestration-ready. Sequestration ready is best defined by the Kinder Morgan standards. The Kinder Morgan company has set the following specifications for pipeline CO₂
a. Product—Substance containing at least ninety five mole percent (95%) of Carbon Dioxide.
b. Water—Product shall contain no free water, and shall not contain more than 13.6 kg (30 pounds) of water per mmcf in the vapor phase. The specification for vapor phase water of 13.6 kg (30 Ibm) per mmscf is equivalent to 264 ppmw using an average molecular weight of 43.2 (based on 95 mol % CO₂ and 5% N₂).
c. Hydrogen Sulfide—Product shall not contain more than twenty (20 ppmw) parts per million, by weight, of hydrogen sulfide.
d. Total Sulfur—Product shall not contain more than thirty five (35 ppmw) parts per million, by weight, of total sulfur.
e. Temperature—Product shall not exceed a temperature of 49 degrees C. (120 degrees F.).
f. Nitrogen—Product shall not contain more than four mole percent (4%) of Nitrogen.
g. Hydrocarbons—Product shall not contain more than five mole percent (5%) of hydrocarbons and the dew point of product (with respect to such hydrocarbons) shall not exceed −29 degrees C. (−20 degrees F.).
h. Oxygen—Product shall not contain more than ten (10) parts per million, by weight, of Oxygen.
i. Other—Product shall not contain more than 1.14 liters (0.3 gallons) of glycol per mmcf and at no time shall such glycol be present in a liquid state at the pressure and temperature conditions of the pipeline.

To meet these requirements, a product gas cleanup process has been developed. Leaving the regenerator tower, the gas stream could contain up to 50% H₂O vapor. The consequence of this is that the cost to compress the gas stream will be substantially higher than if the gas stream contained less water vapor. Therefore, the initial step is to condense a substantial portion of the water from the gas stream. Condensation is an inexpensive way to achieve the lower water vapor concentration. The conditions in the regenerator condenser 530 are set to achieve <10% H₂O in the gas stream. In the condensation step, it is important to maintain a minimum water vapor concentration >0.5%. The minimum water vapor concentration is determined by the amount of ammonia remaining in the gas stream after the regen condenser 530. The requirement for a minimum amount of water vapor is due to the following reaction:

2NH₃(g)+CO₂(g)→NH₂COONH₄ (29)

where ammonia and carbon dioxide react in the absence of water to form solid ammonium carbamate. When setting the conditions of the first condenser, the goal is to remove as much water as possible without creating conditions that form ammonium carbamate in the condenser or downstream equipment. The carbamate reaction is favored at low water and high ammonia concentrations and is a function of the amount of water vapor and ammonia vapor that are left in the gas stream after the initial condensation step.

After the regen condenser 530, the gas stream is compressed. There are two benefits, (i) pipeline CO₂ pressure will require the pure CO₂ gas stream to be at >69 bars (1000 psi) and (ii) the increased pressure will make the second condensation step more effective at removing H₂O and the remaining NH₃ vapor prior to the molecular sieves. The compression step will take the gas stream pressure to between 10.3-28 bars (150-400 psia).

In the second condensation step, the conditions are set to achieve H₂O and NH₃ concentrations that are acceptable going into the molecular sieve 536. The goal is to remove as much H₂O and NH₃ as possible with the cooling water available. Adding chillers would improve the capability to remove both H₂O and NH₃ but the increased cost would need to be evaluated to determine if the incremental improvement in removal was worth the additional cost.

In all of this, the focus has been on only H₂O and NH₃ removal. However, in each condensation step where cold dilute aqueous ammonia is formed, CO₂ is also absorbed creating an ammonium bicarbonate solution. Therefore, in setting conditions for condensation to occur, care must be taken to minimize CO₂ reabsorption as this creates a CO₂ recycle loop, which is returned to the regenerator to be reheated.

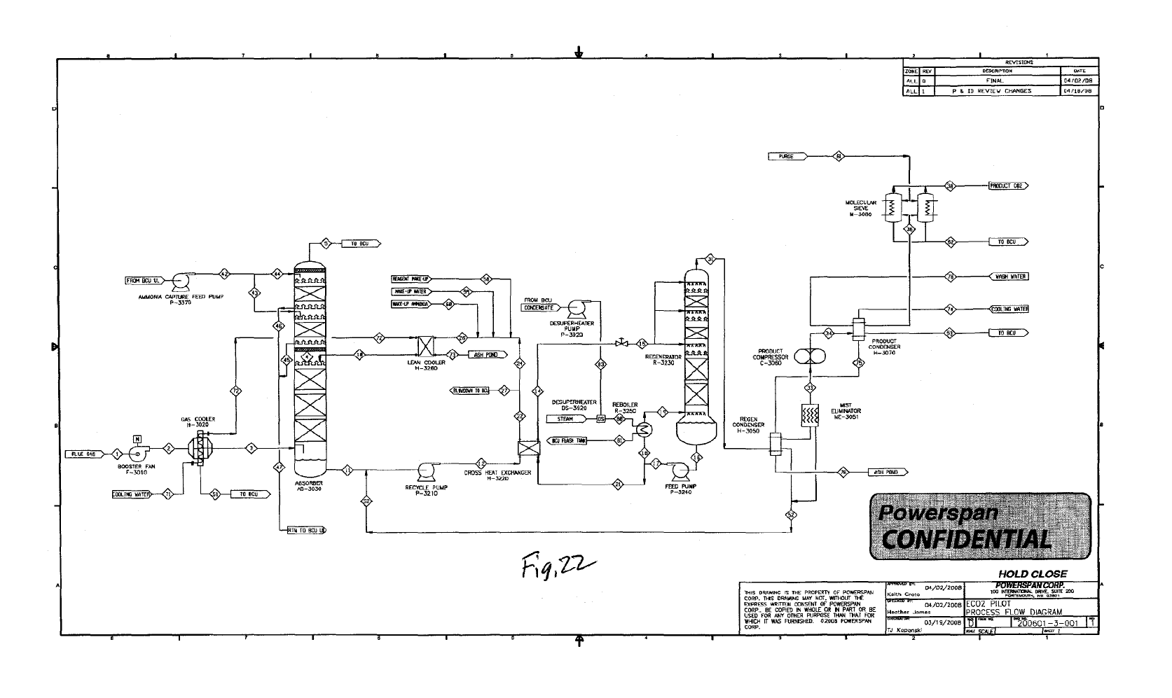

FIG. 22 is a complete process flow diagram (“PFD”) for one embodiment of the entire process of the present invention. The parts are described in detail earlier in this specification.

Shown in Table 4 is experimental data on the removal of water and ammonia vapor from the regenerator gas outlet stream. The table provides the gas composition after cooling at the regenerator gas outlet pressure (first stage) and the pressure following gas compression (second stage).

TABLE 4
Two Stage Condensation and Compression for
H₂O and NH₃ Removal

| | | | | Second |
|---|---|---|---|---|
| | | | First Stage | Stage |
| System | Pressure | (psia) | 28.7 | 130 |
| | Temperature | (F.) | 128 | 71 |
| Gas In | CO₂ | (%) | 30 | 86.9 |
| | NH₃ | (%) | 3.1 | 0.9 |
| | H₂O | (%) | 66.2 | 12.2 |
| Gas Out | CO₂ | (%) | 87.7 | 99.7 |
| | NH₃ | (%) | 0.9 | 0.018 |
| | H₂O | (%) | 11.4 | 0.24 |

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. An apparatus for removing CO₂ from a gas stream comprising:
a. a regenerable carbonate scrubbing solution (402) for CO₂ scrubbing comprising a mixture of alkali carbonates;
b. an absorption tower (102) adapted to create contact between the flue gas and the scrubbing solution and which operates at a temperature between 32 and 66 degrees C. and comprising mass transfer means and liquid distribution means to provide the gas and liquid contact;
c. a regeneration tower (502) to release CO₂ from the scrubbing (402) solution, the regeneration tower comprising:
i. packing for mass transfer (505);
ii. means for allowing the spent scrubbing solution to be introduced at elevated temperature; and
iii. means for introducing heat to the regenerator tower (506);
d. a controller for controlling the absorption and regeneration system parameters selected from the group consisting of gas inlet temperature, reagent feed rates, regeneration temperature and pressure, and system differential pressure; and
e. a heat recovery device (516) to recover energy during the heating and cooling of the absorption and regeneration column liquids.

2. The apparatus of claim 1, the scrubbing solution comprising sodium, potassium and/or ammonium carbonate, wherein the concentration of carbonate is 0-20 wt % and the pH of the solution is 8-12.

3. An apparatus for synergistically removing CO₂, SO₂, Hg, and particulate matter from a gas stream comprising:
an ammonia based scrubbing solution (109) for SO₂ scrubbing;
an SO₂ absorption section (112) to create contact between the flue gas and the ammonia based scrubbing solution to remove SO₂ from the flue gas;
a wet electrostatic precipitator (111) to remove aerosols and fine particulate matter from the flue gas;
a regenerable carbonate scrubbing solution (402) for CO₂ scrubbing comprising a mixture of alkali carbonates;
a CO₂ absorption section (110) for removal of CO₂ adapted to create contact between the flue gas and the scrubbing solution and which operates at a temperature between 32 and 66 degrees C. and comprising mass transfer means and liquid distribution means to provide the gas and liquid contact;
an ammonia absorption section (108) to capture ammonia vapor which creates contact between at least some of the liquid leaving the SO₂ absorption section and the gas leaving the CO₂ absorption section and return ammonia rich liquid leaving the CO₂ absorption section to the SO₂ absorption section for use in SO₂ capture;
a regeneration tower (502) to release CO₂ from the scrubbing solution (402), the regeneration tower comprising:
packing for mass transfer;
means for allowing the spent scrubbing solution to be introduced at elevated temperature; and
means for introducing heat to the regenerator tower (506);
a controller for controlling the absorption and regeneration system parameters selected from the group consisting of gas inlet temperature, reagent feed rates, regeneration temperature and pressure, and system differential pressure; and
a heat recovery device (516) to recover energy during the heating and cooling of the absorption and regeneration column liquids.

4. The apparatus of claim 3, the scrubbing solution comprising sodium, potassium and/or ammonium carbonate, wherein the concentration of carbonate is 0-20 wt % and the pH of the solution is 8-12.

5. The apparatus of claim 3, the ammonia capture section comprising a mass transfer to create contact between the flue gas and scrubbing solution to remove ammonia vapor that is released during CO₂ scrubbing.

6. The apparatus of claim 3, the ammonia capture solution comprising an ammonia based scrubbing solution used for the SO₂ scrubber.

7. The apparatus of claim 3 where the WESP is replaced with a bag house or fabric filter.

8. The apparatus of claim 3 further comprising a gas cooler (115) for condensing water vapor from the gas stream before the CO₂ absorption section (110).

9. An apparatus for synergistically removing CO₂, SO₂, NOₓ, Hg, and particulate matter from a gas stream comprising:
an ammonia based scrubbing solution (109) for SO₂ and NOₓ scrubbing;
a means of oxidation to convert NO to NO₂ and HNO₃;
an SO₂/NO₂ absorption tower to create contact between the flue gas and the ammonia based scrubbing solution to remove SO₂ and NO₂ from the flue gas;
a wet electrostatic precipitator (111) to remove aerosols and fine particulate matter from the flue gas;
a regenerable carbonate scrubbing solution (402) for CO₂ scrubbing containing a mixture of alkali carbonates;
a CO₂ absorption section (110) to create contact between the flue gas and the scrubbing solution, which operates at a temperature between 32 and 66 degrees C. and comprising a mass transfer means and liquid distribution means to provide the gas and liquid contact;
an ammonia absorption section (108) to capture ammonia vapor which creates contact between all or a portion of the liquid leaving the first absorption section and the gas leaving the CO₂ absorption section and return ammonia rich liquid leaving the CO₂ absorption section to the SO₂/NO₂ absorption section for use in SO₂ capture;
a regeneration section 502 to release CO₂ from the scrubbing solution, the regeneration tower comprising:
packing for mass transfer;
means for allowing the spent scrubbing solution to be introduced at elevated temperature; and
means for introducing heat to the regenerator tower;
a controller for controlling the absorption and regeneration system parameters selected from the group consisting of gas inlet temperature, reagent feed rates, regeneration temperature and pressure, and system differential pressure; and
a heat recovery device to recover energy during the heating and cooling of the absorption and regeneration column liquids.

10. The apparatus of claim 9 the scrubbing solution comprising sodium, potassium and/or ammonium carbonate, wherein the concentration of carbonate is 0-20 wt % and the pH of the solution is 8-12.

11. The apparatus of claim 9 wherein the WESP is replaced with a bag house or fabric filter.

12. The apparatus of claim 9 where the oxidation means is a dielectric barrier discharge reactor.

13. The apparatus of claim 12 where an additive comprising propene or H₂O₂ is used to improve oxidation efficiency of the dielectric discharge reactor.

14. A process for removing CO₂ from a gas stream comprising the steps of:
absorbing CO₂ with a carbonate solution between 32 and 66 degrees C.;
regenerate the carbonate solution by heating and releasing CO₂;
controlling the absorbing and regenerating steps using inputs selected from the group consisting of gas inlet temperature, reagent feed rates, regeneration temperature and pressure, and system differential pressure; and
providing a heat recovery device.

15. The process of claim 14 wherein the carbonate solution comprises alkali carbonates, the carbonate solution concentration is between 0 and 20 wt % and the pH of the carbonate solution is between 8 and 12.

16. A method for producing a CO₂ stream from the decomposition of ammonium carbonate comprising the steps of:
washing a gas stream containing CO₂, ammonia, and water with a CO₂-rich carbonate solution (354); followed by
condensing at least some of the water from the gas stream by cooling (356); followed by
drying the gas stream so that it has a dewpoint of −40 degrees C. thereby removing substantially all of the water; and
compressing the remaining gas.

17. The method of claim 16, wherein the CO₂-rich carbonate solution is between 38 degrees C. and 66 degrees C.

18. The method of claim 16, wherein the cooling cools the gas stream to less than 54 degrees C.

19. The method of claim 16, further comprising the step of scrubbing CO₂ with an ammonium carbonate solution (346) before the washing step (354).

20. A method of controlling carbonate/bicarbonate concentrations in a chemical process comprising the steps of:
flowing a carbonate/bicarbonate solution through a measurement cell;
exposing the solution to laser light of suitable wavelength and power;
measuring the intensity of the scattered light using Raman spectroscopy;
calculating the concentration of carbonate and bicarbonate from the intensity of the scattered light; and
sending the measurement results to a programmable logic controller (466) to be used to control the ratio of carbonate to bicarbonate and total carbonate concentration in the solution through adjusting process parameters.

21. A method of controlling bicarbonate/carbonate concentrations in a CO₂ absorption process comprising the steps of:
providing a lean bicarbonate/carbonate solution having a bicarbonate/carbonate ratio of less than 1 (456);
measuring the lean bicarbonate/carbonate composition with a first Raman spectrometer (468);
absorbing CO₂ (458) with a bicarbonate/carbonate solution, thereby producing a rich bicarbonate/carbonate solution having a bicarbonate/carbonate ratio greater than 1 (464);
measuring the rich bicarbonate/carbonate solution with a second Raman spectrometer (470); and
sending the lean bicarbonate/carbonate composition measurement and rich bicarbonate/carbonate to a programmable logic controller (466) for controlling the CO₂ absorption process (458).

22. A method of controlling alkali bicarbonate/carbonate solutions in a bicarbonate/carbonate regeneration process comprising the steps of:
providing a rich bicarbonate/carbonate solution having a bicarbonate/carbonate ratio greater than 1 (474);
measuring the rich bicarbonate/carbonate solution with a first Raman spectrometer (480);
regenerating the bicarbonate/carbonate solution (476) thereby producing CO₂ (484) and a lean bicarbonate/carbonate solution having a bicarbonate/carbonate ratio of less than 1 (472);
measuring the lean bicarbonate/carbonate solution with a second Raman spectrometer (478); and
sending the rich bicarbonate/carbonate composition measurement and lean bicarbonate/carbonate to a programmable logic controller (482) for controlling the regeneration process (476).

23. A method of treating a CO₂ removal product gas stream gas stream comprising CO₂ ammonia, and water vapor comprising the steps of:
condensing the gas stream with a regenerator condenser by chilling so that there is between 0.5% and 10% water by weight in the gas stream (530); followed by
compressing the gas stream with a product compressor to a pressure between 10.3 and 27.6 bar (532); followed by
condensing the gas stream with a product condensor by chilling while maintaining greater than 0.5% water by weight in the gas stream; followed by
removing water and ammonia from the gas stream with a molecular sieve (536).
